(19) United States
(12) Patent Application Publication
(10) Pub. No.: US 2015/0007016 A1
(43) Pub. Date: Jan. 1, 2015

(54) MOBILE TERMINAL AND METHOD OF OPERATING THE SAME

(71) Applicant: Samsung Electronics Co., Ltd., Suwon-si (KR)

(72) Inventors: Yong-yeon LEE, Suwon-si (KR); Ji-Yeon KWAK, Seoul (KR); Hyun-jin KIM, Seoul (KR); Joon-kyu SEO, Seoul (KR)

(73) Assignee: Samsung Electronics Co., Ltd., Suwon-si (KR)

(21) Appl. No.: 14/295,756

(22) Filed: Jun. 4, 2014

(30) Foreign Application Priority Data
Jul. 1, 2013 (KR) 10-2013-0076628

(51) Int. Cl. G06F 17/22; G06F 3/0481; G06F 3/0484; G06F 3/0482; G06F 3/0485

(52) U.S. Cl. CPC G06F 17/2247; G06F 3/0482; G06F 3/0485; G06F 3/0484; G06F 3/0481; G06F 17/2276
USPC 715/234; 715/810; 715/784; 715/716; 715/788; 715/259

(57) ABSTRACT

Provided are a mobile terminal and a method operating the mobile terminal. The method includes: receiving a user input; performing a first operation corresponding to the user input; successively receiving the user input for a predetermined number of times or more within a predetermined time period; and performing a second operation based on a number of the successively received user input, wherein the second operation is set in advance in relation to the first operation.

### CROSS-REFERENCE TO RELATED APPLICATIONS

This application claims priority from Korean Patent Application No. 10-2013-0076628, filed on Jul. 1, 2013 in the Korean Intellectual Property Office, the disclosure of which is incorporated herein in its entirety by reference.

### BACKGROUND

1. Field

Apparatuses and methods consistent with exemplary embodiments of the inventive concept relate to a mobile terminal and, and more particularly, to a mobile terminal that is capable of performing an appropriate operation when repeatedly receiving a user input and a method of operating the mobile terminal.

2. Description of the Related Art

A mobile terminal is a portable device having one or more functions, for example, a function of performing a voice call and a video call while moving, a function of inputting or outputting information, and a function of storing data. Such a mobile terminal nowadays has various functions such as capturing a picture or a moving picture, reproducing of a music file or a moving picture file, receiving a broadcast, and wirelessly connecting to the Internet, and thus, the mobile terminal is configured as a multimedia player.

In addition, a user of the mobile terminal may have to repeatedly input a certain user input in order to perform a certain operation, for example, repetition of a flicking input in order to search for a number in a list of telephone numbers.

In this case, the user may be inconvenienced due to having to repeat the same operation.

### SUMMARY

One or more exemplary embodiments provide a mobile terminal that is configured to perform an operation suitable for the intention of a user when a user input is repeatedly input, and a method of operating the mobile terminal.

Various aspects will be set forth in part in the description which follows and, in part, will be apparent from the description, or may be learned by practice of the presented embodiments.

According to an aspect of an exemplary embodiment, there is provided a method of operating a mobile terminal which may include: receiving a user input; performing a first operation corresponding to the user input; successively receiving the user input for a predetermined number of times or more within a predetermined time period; and performing a second operation based on a number of the successively received user input, wherein the second operation is set in advance in relation to the first operation.

The method may further include displaying a program execution screen, and the first operation and the second operation may be operations based on characteristics of the program execution screen.

The first operation and the second operation may be based on a kind of the user input.

The method may further include displaying a list screen including a list, and if the user input is an input of flicking the list screen, the performing the first operation may include scrolling the list, and the performing the second operation may include grouping items in the list based on a predetermined reference and scrolling groups of the list.

The method may further include displaying a list screen including a list, and if the user input is an input of flicking the list screen, the performing the first operation may include scrolling the list, and the performing the second operation may include highlighting a predetermined portion of the list, scrolling a portion that is not highlighted faster than a predetermined speed, and scrolling the highlighted predetermined portion of the list slower than the predetermined speed.

The predetermined list may be magnified.

The method may further include displaying a list screen including a list, and if the user input is an input of drawing a predetermined pattern on the list screen, the performing the first operation may include filtering items in the list according to a first reference, and the performing the second operation may include rearranging the filtered items in the list based on a second reference.

The predetermined pattern may be a circular pattern, and the second reference may be determined according to a direction of drawing the circular pattern.

The list screen may be a phone number list screen, and if the circular pattern is drawn in a clockwise direction, the filtered items in the list may be rearranged in an order of frequently called, and if the circular pattern is drawn in a counter-clockwise direction, the filtered items in the list may be rearranged in an order of less called.

The performing the second operation may reducing or increasing a number of items in the list that are rearranged, based on a number of the successively received user input of drawing the predetermined pattern.

The predetermined pattern may be a circular pattern, and the performing the second operation may include reducing a number of items in the list that are rearranged whenever an input of drawing the circular pattern in the clockwise direction is received, and increasing the number of items in the list that are rearranged whenever an input of drawing the circular pattern in the counter-clockwise direction is received.

The method may further include displaying a screen including application icons representing applications, and if the user input is an input of tapping one of the application icons, the performing the first operation may include executing an application corresponding to the tapped application icon, and the performing the second operation may include displaying a lower level menu that is related to the application.

The method may further include entering a photographing mode and displaying a camera screen including a photographing icon, and if the user input is an input of tapping the photographing icon, the performing of the first operation may include capturing an image displayed on the camera screen once, and the performing of the second operation may include successively capturing images displayed on the camera screen in a stop motion mode.

The method may further include entering an album mode and displaying an album screen including images, wherein if the user input is an input of tapping an object included in one of the images, the performing of the first operation may include tagging the object, and the performing of the second operation may include searching for an image including the object from among the images included in the album screen and displaying the found image.

The method may further include displaying a text screen, and if the user input is an input of tapping a word included in the text screen, the performing of the first operation may include selecting the word, and the performing of the second operation may include displaying information that is related to the selected word.

The information that is related to the selected word may include a result of searching for the word.

The method may further include displaying an application execution screen, wherein if the user input is a certain key input, the performing of the first operation may include displaying a previous screen of the application execution screen, and the performing of the second operation may include displaying a list of previous screens including previous screens of the application execution screen.

The method may further include displaying a music play screen, and if the user input is an input of knocking an object contacting the mobile terminal, the performing of the first operation may include reproducing a next song of a currently played song, the performing the second operation may include jumping to next songs continuously until another user input is received after the predetermined time period and reproducing a song to which the jumping is made when the other user input is received.

According to an aspect of another exemplary embodiment, a mobile terminal may include: a display unit configured to display information processed by the mobile terminal; and a control unit configured to receive a user input to perform a first operation corresponding to the user input, and successively receive the user input for a predetermined number of times within a predetermined time period for performing a second operation based on a number of the successively received user input, wherein the second operation is set in advance in relation to the first operation.

The display unit may display a program execution screen, and the first operation and the second operation may be based on characteristics of the program execution screen.

The first operation and the second operation may be based on a kind of the user input.

The display unit may display a list screen including a list, and when the user input is an input of flicking the list screen, the first operation may be an operation of scrolling the list, and the second operation may be an operation of grouping items in the list based on a predetermined reference and scrolling the groups of the list.

The display unit may display a list screen including a list, and if the user input is an input of flicking the list screen, the first operation may be an operation of scrolling the list, and the second operation may be an operation of highlighting a predetermined portion of the list, scrolling a portion of the list that is not highlighted faster than a predetermined speed when performing the first operation, and scrolling the highlighted predetermined portion of the list slower than the predetermined speed.

The control unit may magnify the predetermined portion of the list.

The display unit may display a list screen including a list, and if the user input is an input of drawing a predetermined pattern on the list screen, the first operation may be an operation of filtering items in the list according to a first reference, and the second operation may be an operation of rearranging the filtered items in the list based on a second reference.

The predetermined pattern may be a circular pattern, and the second reference may be determined according to a direction of drawing the circular pattern.

The list screen may be a phone number list screen, if the circular pattern is drawn in a clockwise direction, the control unit may rearrange the filtered items in the list in an order of frequently called, and if the circular pattern is drawn in a counter-clockwise direction, the control unit may rearrange the filtered items in the list in an order of less called.

The control unit may reduce or increase a number of items in the list that are rearranged, based on a number of the successively received user input of drawing the predetermined pattern.

The predetermined pattern may be a circular pattern, and the control unit may reduce a number of items in the list that are rearranged whenever an input of drawing the circular pattern in the clockwise direction is received, and increase the number of items in the list that are rearranged whenever an input of drawing the circular pattern in the counter-clockwise direction is received.

The display unit may display a screen including application icons representing applications, and if the user input is an input of tapping one of the application icons, the first operation may be an operation of executing the application, and the second operation may be an operation of displaying a lower level menu that is related to the application.

The display unit may display a camera screen including a photographing icon, and if the user input is an input of tapping the photographing icon, the first operation may be an operation of capturing an image displayed on the camera screen once, and the second operation may be an operation of successively capturing images displayed on the camera screen in a stop motion mode.

The display unit may display an album screen including images, and if the user input is an input of tapping an object included in one of the images, the first operation may be an operation of tagging the object, and the second operation may be an operation of searching for an image including the object from among the images included in the album screen and displaying the found image.

The display unit may display a text screen, and if the user input is an input of tapping a word included in the text screen, the first operation may be an operation of selecting the word, and the second operation may be an operation of displaying information that is related to the selected word.

The information that is related to the selected word may include a result of searching for the word.

The display unit may display an application execution screen, and if the user input is a certain key input, the first operation may be an operation of displaying a previous screen of the application execution screen, and the second operation may be an operation of displaying a list of previous screens including previous screens of the application execution screen.

The display unit may display a music play screen, and if the user input is an input of knocking an object contacting the mobile terminal, the first operation may be an operation of reproducing a next song of a currently played song, and the second operation may be an operation of jumping to next songs continuously until another user input is received after the predetermined time period, and reproducing a song to which the jumping is made when the other user input is received.

According to an aspect of still another exemplary embodiment, a method of operating a mobile terminal, the method includes: displaying a web page; receiving a back button input; displaying a previous page of the web page; successively receiving the back button input for a first number of times or more within a predetermined time period; and displaying a list of previous pages of the web page.

The list of previous pages may be a list of thumbnails of the previous pages.

The method may further include: selecting one previous page of the list of previous pages; and displaying the selected previous page.

The method may further include: successively receiving the back button input for a second number of times or more within a predetermined time period; and displaying a preset page, wherein the second number of times may be greater than the first number of times.

### BRIEF DESCRIPTION OF THE DRAWINGS

These and/or other aspects will become apparent and more readily appreciated from the following description of the exemplary embodiments, taken in conjunction with the accompanying drawings, in which:

FIG. 1 is a block diagram of a mobile terminal according to an exemplary embodiment;

FIG. 2 is a block diagram of the mobile terminal according to an exemplary embodiment in more detail;

FIG. 3 is a diagram showing an outer appearance of the mobile terminal according to an exemplary embodiment;

FIG. 4 is a flowchart of a method of operating a mobile terminal according to an exemplary embodiment;

FIGS. 5A through 16B are diagrams for illustrating methods of operating a mobile terminal with screens displayed on a display unit of the mobile terminal, according to exemplary embodiments;

FIG. 17 is a flowchart of a method of operating a mobile terminal, according to another exemplary embodiment; and

FIGS. 18A through 18F are diagrams for illustrating the method shown in FIG. 17 with the screens displayed on the display unit of the mobile terminal, according to exemplary embodiments.

### DETAILED DESCRIPTION OF EXEMPLARY EMBODIMENTS

Reference will now be made in detail to exemplary embodiments which are illustrated in the accompanying drawings, wherein like reference numerals refer to like elements throughout.

In the present specification, a mobile terminal may include a mobile phone, a smartphone, a notebook computer, a digital broadcasting terminal, a personal digital assistant (PDA), a portable multimedia player (PMP), a camera, a navigation system, a tablet computer, or an e-book terminal. Also, expressions such as “unit” and “module” stated in the specification denote units that process at least one function or operation, and they may be implemented by hardware, software, or a combination of hardware and software.

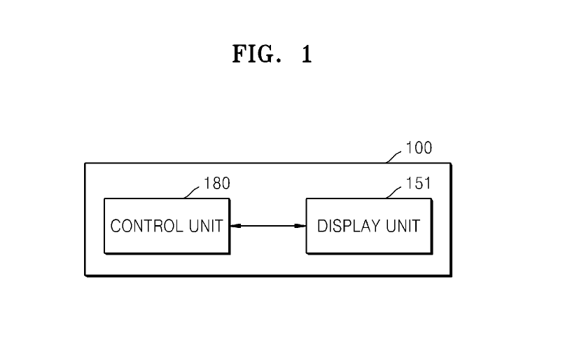

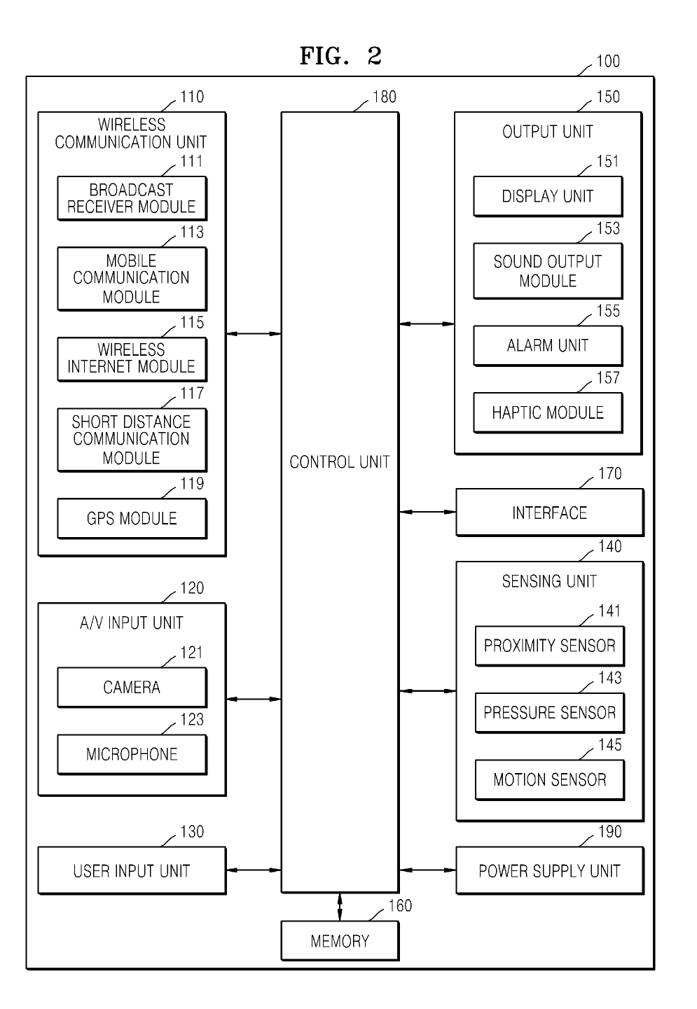

FIG. 1 is a block diagram of a mobile terminal 100 according to an exemplary embodiment.

The mobile terminal 100 according to the present embodiment may include a display unit 151 and a control unit 180.

According to the present embodiment, when the control unit 180 receives a user input, the control unit 180 performs a first operation, and when the user input is input successively for a predetermined number of times or more within a predetermined time period, the control unit 180 may perform a second operation based on the number of times of receiving the user input successively.

According to the present embodiment, the display unit 151 may display a program execution screen, and the control unit 180 may perform the first operation and the second operation based on properties of the program execution screen.

According to the embodiment, the control unit 180 may perform the first operation and the second operation based on a kind of the user input.

According to the embodiment, the display unit 151 may display a list screen. When receiving an input of flicking the list screen, the control unit 180 may scroll the list. When receiving the input of flicking the list screen for a predetermined number of times or more within a predetermined time period, the control unit 180 may perform an operation of grouping the list based on a predetermined reference and scrolling the screen by group units.

Also, when receiving a user input of flicking the list screen, the control unit 180 highlights a principal list in the list screen, and then, the control unit 180 scrolls a list that is not highlighted faster than a predetermined speed and scrolls the principal list that is highlighted slower than the predetermined speed. Also, the control unit 180 may magnify or enlarge the principal list.

According to the embodiment, when receiving a user input of drawing a predetermined pattern on the list screen, the control unit 180 may display a list that is filtered based on a first reference.

Also, when receiving the user input of drawing the predetermined pattern on the list screen successively for a predetermined number of times or more within a predetermined time period, the control unit 180 may rearrange the list that is filtered based on the first reference, according to a second reference.

In addition, the predetermined pattern may be a circular pattern, and the second reference may be determined according to a direction of drawing the circular pattern.

The list screen may be a list screen of telephone numbers. When receiving a user input of drawing the circular pattern in a clockwise direction, the control unit 180 may rearrange and display the list in an order of frequently connected telephone numbers. Otherwise, when receiving a user input of drawing the circular pattern in a counter-clockwise direction, the control unit 180 may rearrange and display the list in an order of less connected telephone numbers.

Also, the control unit 180 may increase or reduce the number of lists that are rearranged and displayed, based on the number of times of successively receiving the input of drawing the predetermined pattern.

If the predetermined pattern is a circular pattern, the control unit 180 may reduce the number of lists that are rearranged and displayed whenever it receives the input of drawing the circular pattern in the clockwise direction. On the contrary, the control unit 180 may increase the number of lists that are rearranged and displayed whenever it receives the input of drawing the circular pattern in the counter-clockwise direction.

According to the present embodiment, the display unit 151 may display a screen including an application icon that represents an application.

In addition, the control unit 180 may execute the application when receiving an input of tapping the application icon. When receiving the input of successively tapping the application icon for a predetermined number of times or more within a predetermined time period, the control unit 180 may display a lower level menu that is related to the application.

According to the present embodiment, the display unit 151 may display a camera screen including a photographing icon.

The control unit 180 may control to capture an image displayed on the camera screen once when receiving an input of tapping the photographing icon. In addition, when receiving the input of tapping the photograph icon successively for a predetermined number of times or more within a predetermined time period, the control unit 180 may perform a stop motion photographing operation, in which an image displayed on the camera screen is successively captured.

According to the present embodiment, the display unit 151 may display an album screen including images.

Also, when receiving an input of tapping an object included in an image, the control unit 180 may tag the tapped object. In addition, when receiving the input of tapping the object successively for a predetermined number of times or more within a predetermined time period, the control unit 180 may search for an image including the tapped object from among the images displayed on the album screen or included in a corresponding album and display the image.

According to the present embodiment, the display unit 151 may display a text screen.

Also, the control unit 180 may select a word when receiving an input of tapping the word included in the text screen. In addition, when receiving the input of tapping the word included in the text screen for a predetermined number of times or more within a predetermined time period, the control unit 180 may display information that is related to the tapped word.

The information that is related to the tapped word may be a search result of the tapped word. The search result may be from a dictionary stored in the mobile terminal 100 or connected through the Internet, according to an exemplary embodiment.

Also, according to the present embodiment, the display unit 151 may display a music reproducing screen.

The control unit 180 may reproduce a tune next to a currently reproduced tune, when receiving an input of knocking an object contacting the mobile terminal 100. Also, when receiving the input of knocking the object contacting the mobile terminal 100 for a predetermined number of times or more within a predetermined time period, the control unit 180 may continuously move to a next tune and reproduce the tune until a next knock input is input.

According to the present embodiment, the display unit 151 may display a web page.

The control unit 180 may display a previous page of the web page when receiving a back button input. Also, when receiving the back button input for a first number of times or more successively within a predetermined time period, the control unit 180 may display a list of previous pages of the current web page.

The list of the previous pages may be a list of thumbnails of the previous pages.

In addition, when receiving an input of selecting one previous page of the previous page list, the control unit 180 may display the selected previous page.

Also, when receiving the back button input successively for a second number of times or more within a predetermined time period, the control unit 180 may display a preset page. Here, the second number of times may be greater than the first number of times.

FIG. 2 is a block diagram of a mobile terminal 100 according to another exemplary embodiment. The mobile terminal 100 according to the present embodiment will be described in view of functional elements, with reference to FIG. 2.

Referring to FIG. 2, the mobile terminal 100 includes a wireless communication unit 110, an audio/video (A/V) input unit 120, a user input unit 130, a sensing unit 140, an output unit 150, a memory 160, an interface 170, a control unit 180, and a power supply unit 190. According to exemplary embodiments, two or more of these units may be combined as one unit and one unit may be divided into two or more units as necessary.

The wireless communication unit 110 may include a broadcast receiver module 111, a mobile communication module 113, a wireless Internet module 115, a short distance communication module 117, and a global positioning system (GPS) module 119.

The broadcast receiver module 111 receives at least one of a broadcast signal and broadcast-related information from an external broadcast management server via a broadcast channel. The external broadcast management server may be a server generating and transmitting at least one of the broadcast signal and the broadcast-related information, and a server provided with the broadcast signal and the broadcast-related information that is generated in advance to be transmitted to the mobile terminal.

The broadcast signal may include a TV broadcast signal, a radio broadcast signal, and a data broadcast signal, and additionally, may include a broadcast signal generated by combining the TV broadcast signal or the radio broadcast signal with the data broadcast signal. The broadcast-related information may be information that is related to a broadcast channel, a broadcast program, or a broadcast service provider. The broadcast-related information may be provided via a mobile communication network, and in this case, the information may be received through the mobile communication module 113. The broadcast-related information may have various formats, for example, an electronic program guide (EPG) for digital multimedia broadcasting (DMB) or electronic service guide (ESG) for digital video broadcasting-handheld (DVB-H).

The broadcast receiver module 111 receives broadcast signals by using various broadcasting systems, for example, digital multimedia broadcasting-terrestrial (DMB-T), digital multimedia broadcasting-satellite (DMB-S), media forward link only (MediaFLO), DVB-H, and integrated services digital broadcast-terrestrial (ISDB-T), without being limited thereto. Also, the broadcast receiver module 111 may be configured to be suitable for all kinds of broadcasting systems providing broadcast signals, as well as the digital broadcasting systems. The broadcast signal and/or the broadcast-related information received through the broadcast receiver module 111 may be stored in the memory 160.

The mobile communication module 113 transmits/receives wireless signals to/from at least one of a base station, an external terminal, and a server over a mobile communication network. Here, the wireless signal may include a voice call signal, a video call signal, or various kinds of data according to transmission of text/multimedia messages.

The wireless Internet module 115 is a module for wirelessly connecting to the Internet. The wireless Internet module 115 may be built in the mobile terminal 100 or provided outside the mobile terminal 100. A wireless internet technology such as Wireless LAN (WLAN), wireless fidelity (Wi-Fi), wireless broadband (WiBro), world interoperability for microwave access (WiMAX), or high-speed downlink packet access (HSDPA) may be used.

The short distance communication module 117 is a module for short distance communication, for example, Bluetooth, radio frequency identification (RFID), infrared data association (IrDA), ultra wideband (UWB), or ZigBee.

The GPS module 119 receives location information from GPS satellites.

The A/V input unit 120 is an input unit via which an audio signal or a video signal is input, and may include a camera 121 and a microphone 123. The camera 121 processes an image frame of a still image or a moving picture obtained by an image sensor in a video call mode or a photographing mode. In addition, the processed image frame may be displayed on the display unit 151.

The image frame processed by the camera 121 may be stored in the memory 160 or may be transferred to the outside via the wireless communication unit 110. According to a configuration of the mobile terminal 100, one or more cameras 121 may be provided.

The microphone 123 receives an external sound signal and processes the external sound signal into electric voice data in a phone call mode, a voice recording mode, or a voice recognition mode. In addition, in a phone call mode, the voice data may be converted into a format that may be transferred to a mobile communication base station via the mobile communication module 113. The microphone 123 may use various noise reduction algorithms for removing noise generated during the input of the external sound signal.

The user input unit 130 generates key input data input by a user to control operations of the mobile terminal 100. The user input unit 130 may include a keypad, a dome switch, and a touch pad (resistive/capacitive) that may receive a command or information through a pushing or touching operation of the user. Also, the user input unit 130 may be configured in a form to manipulate such as a jog wheel or a joystick, or a finger mouse. In particular, if a touch pad forms a layer structure with the display unit 151 that will be described later, this may be referred to as a touch screen.

The sensing unit 140 generates a sensing signal for controlling an operation of the mobile terminal 100 by sensing a current status of the mobile terminal 100 such as an opening/closing status of the mobile terminal 100, a location of the mobile terminal 100, and a user contact status. For example, if the mobile terminal 100 is a slide phone type, the sensing unit 140 may detect whether the slide phone is opened or closed. Also, the sensing unit 140 may detect whether the electric power is supplied from the power supply unit 190, or whether the interface 170 is coupled to an external device.

The sensing unit 140 may include a proximity sensor 141, a pressure sensor 143, and a motion sensor 145. The proximity sensor 141 may detect an object that approaches the mobile terminal 100 or an object that is around the mobile terminal 100 without any mechanical contact. The proximity sensor 141 may detect an adjacent object by using a change in an alternating current (AC) magnetic field or a magnetostatic field, or a changing rate of a static capacity.

The pressure sensor 143 may detect whether a pressure is applied to the mobile terminal 100, and a magnitude of the pressure. The pressure sensor 143 may be provided to a portion where the pressure needs to be detected in the mobile terminal 100. If the pressure sensor 143 is provided on the display unit 151, a touch input through the display unit 151 and a pressure touch input applying a greater pressure than that of the touch input may be distinguished from each other according to a signal output from the pressure sensor 143. Also, a magnitude of the pressure applied to the display unit 151 when a pressure touch is input may be recognized, according to the signal output from the pressure sensor 143.

The motion sensor 145 may detect a location of the mobile terminal 100 or a motion of the mobile terminal 100 by using an acceleration sensor or a gyro sensor. The acceleration sensor that may be used as the motion sensor 145 is a device for converting an acceleration change in a direction into an electric signal, and is widely used in accordance with development of a micro-electromechanical systems (MEMS) technology. Also, the gyro sensor is a sensor for measuring an angular velocity, and thus, may detect a rotation direction based on a reference direction.

The output unit 150 outputs an audio signal, a video signal, or an alarm signal. The output unit 150 may include the display unit 151, a sound output module 153, an alarm unit 155, and a haptic module 157.

The display unit 151 displays information processed by the mobile terminal 100. For example, when the mobile terminal 100 is in a phone call mode, a user interface (UI) or a graphical user interface (GUI) that relates to the call mode is displayed. In addition, when the mobile terminal 100 is in a video call mode or a photographing mode, the display unit 151 may display images that are received or photographed at the same time or one by one, and also displays a UI or a GUI.

As described above, when the display unit 151 and a touch pad form a layer structure to configure a touch screen, the display unit 151 may be used as an input device for receiving information input by a touch of the user, as well as an output device.

If the display unit 151 is configured as a touch screen, the touch screen may include a touch screen panel and a touch screen panel controller. In this case, the touch screen panel is a transparent panel attached to an outer portion of the touch screen, and may be connected to an internal bus of the mobile terminal 100. The touch screen panel transfers signals corresponding to a touch input to the touch screen panel controller. The touch screen panel controller processes the signals and transfers data corresponding to the processed signals to the control unit 180 so that the control unit 180 determines whether there is a touch input and which portion of the touch screen is touched.

The display unit 151 may be configured as an electronic paper (e-paper). The e-paper is a kind of reflective display having a high resolution, wide viewing angles, and an excellent visibility based on a bright white background, like real paper and ink. The e-paper may be realized on any kind of substrate, for example, plastic, metal, and paper. In addition, the image may remain after electric power is turned off, and there is no backlight, and thus, a lifespan of a battery in the mobile terminal 100 may be increased. Otherwise, the display unit 151 may include at least one of a liquid crystal display, a thin film transistor-liquid crystal display, an organic light-emitting diode display, a flexible display, and a three-dimensional (3D) display.

The sound output module 153 outputs audio data transmitted from the wireless communication unit 110 or stored in the memory 160 in a call signal reception, a phone call mode or a voice recording mode, a voice recognition mode, or a broadcasting reception mode. Also, the sound output module 153 outputs a sound signal that is related to functions performed by the mobile terminal 100, for example, a call signal reception sound or a message reception sound. The sound output module 153 may include a speaker or a buzzer.

The alarm unit 155 outputs a signal for notifying an occurrence of an event of the mobile terminal 100. Examples of the event occurring in the mobile terminal 100 may include a call signal reception, a message reception, a key signal input, and the like. The alarm unit 155 outputs a signal for notifying the event occurrence by using a format other than the audio signal or the video signal. The alarm unit 155 may output a signal when a call signal or a message is received. Also, when a key signal is input, the alarm unit 155 may output a signal as feedback to the key signal input. The user may recognize the occurrence of the event through the signal output from the alarm unit 155. The signal for notifying the occurrence of the event in the mobile terminal 100 may be output through the display unit 151 or the sound output module 153.

The haptic module 157 generates various tactile effects that the user may sense. The tactile effects generated by the haptic module 157 may include a vibration effect. When the haptic module 157 generates the vibration as the tactile effect, an intensity or a pattern of the vibration may be changed, and vibrations having different patterns may be combined or may be output sequentially.

The haptic module 157 may generate various tactile effects, for example, a stimulus effect by arranging pins moving perpendicularly to contact a surface of the skin, a stimulus effect by ejecting or sucking of air through an eject hole or a suction hole, an effect by stimulating the surface of the skin, a stimulus effect through contact with an electrode, a stimulus effect by using an electrostatic force, and an effect by reproducing coolness and warmth by using a device absorbing or generating heat. The haptic module 157 may transfer the tactile effect through direct contact, and moreover, may be configured to allow the user to sense the tactile effect through touch sensing such as a finger or an arm of the user.

The memory 160 may store a program for processing and controlling the control unit 180, or may temporarily store input/output data (for example, a phone book, messages, still images, moving pictures, and the like).

The memory 160 may include a storage medium of at least one of a flash memory type, a hard disk type, a multimedia card micro type, a card type (for example, an SD or an XD memory), random access memory (RAM), and read only memory (ROM). Also, the mobile terminal 100 may manage a web storage functioning as the memory 160 on the Internet.

The interface 170 functions as an interface with all kinds of external devices connected to the mobile terminal 100. Examples of the external devices connected to the mobile terminal 100 may include a wired/wireless headset, an external charger, a wired/wireless data port, a memory card, a card socket such as a subscriber identification module (SIM) card and a user identity module (UIM) card, an audio input/output (I/O) terminal, a video I/O terminal, and earphones. The interface 170 receives data or electric power from the external devices to transfer the data or the electric power to each of the components in the mobile terminal 100, and may transfer the data in the mobile terminal 100 to the external devices.

The interface 170 may be a passage to supply electric power from a cradle to the mobile terminal 100 when the mobile terminal 100 is connected to the cradle, or may be a passage through which various command signals may be input from the cradle by the user to the mobile terminal 100.

The control unit 180 generally controls operations of each component to control overall operations of the mobile terminal 100. For example, the control unit 180 performs controls and processes that are related to a voice call, data communication, and a video call. Also, the control unit 180 may include a multimedia reproduction module for reproducing multimedia. The multimedia reproduction module may be configured as hardware in the control unit 180, or may be configured separately from the control unit 180 as software.

In addition, the power supply unit 190 is provided with external power or internal power according to the control of the control unit 180 to supply the electric power to operate each of the components.

The mobile terminal 100 having the above configuration includes a wired/wireless communication system and a satellite-based communication system, and may be configured to operate in a communication system that may transfer data through a frame or a packet.

According to an exemplary embodiment, two or more of the units illustrated in FIG. 2 may be combined as one unit and one unit may be divided into two or more units as necessary. Also, two or more modules illustrated in FIG. 2 may be combined as one unit and one unit may be divided into two or more units as necessary.

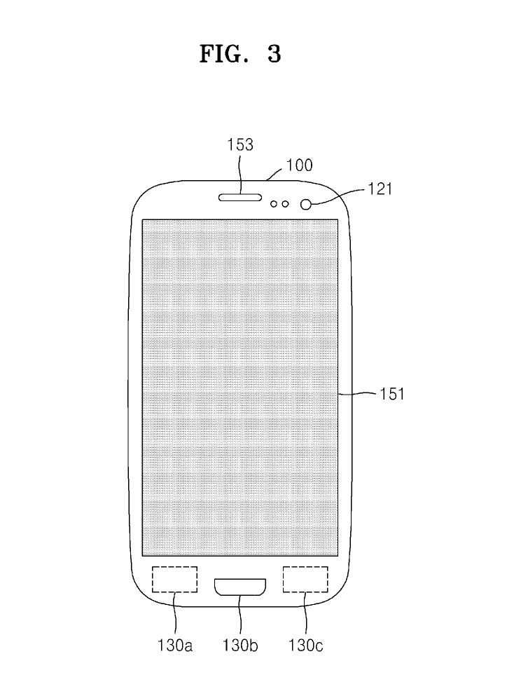

FIG. 3 is a diagram showing an outer appearance of the mobile terminal 100 according to an exemplary embodiment. The mobile terminal 100 according to the present embodiment will be described with regard to external components visible thereon. Hereinafter, for convenience of description, a bar type mobile terminal having a front touch screen will be described from among various types of mobile terminals, for example, a folder type, a bar type, a swing type, and a slider type mobile terminal. However, the embodiments are not limited to the bar type mobile terminal, but may be applied to all types of mobile terminals.

Referring to FIG. 3, the mobile terminal 100 includes the display unit 151, the sound output module 153, the camera 121, and first through third user input units 130a, 130b, and 130c. Although not shown in FIG. 3, the mobile terminal 100 may further include a microphone.

The display unit 151 may be configured to operate as a touch screen so that information may be input by a touch of the user, by overlaying a touch pad in a layered structure.

The sound output module 153 may be configured as a receiver or a speaker. The camera 121 may be configured to capture images or moving pictures. In addition, the microphone (not shown) may receive input of the user's voice and other sounds.

The first through third user input units 130a, 130b, and 130c may be configured as dome switches or touch pads receiving commands or information by a pressing or a touching operation of the user, or may be configured in a form to manipulate such as a jog wheel or a joystick.

According to the present embodiment, the third user input unit 130c may be configured as a back button.

Hereinafter, a method of operating a mobile terminal, according to the embodiment, is described with reference to screens of a display unit of the mobile terminal.

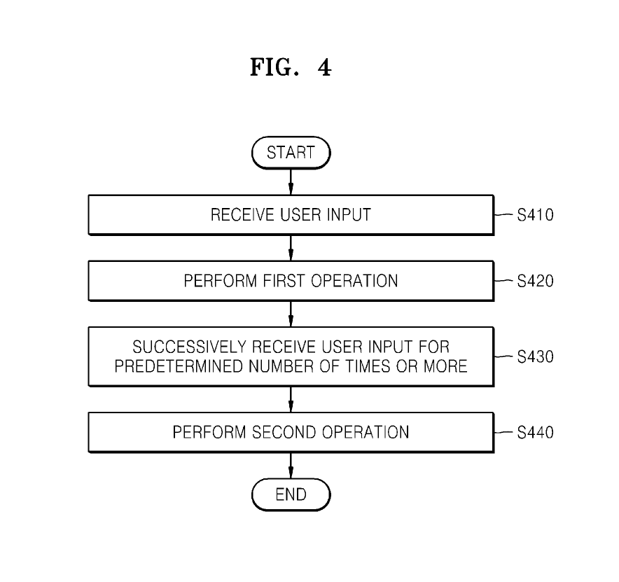

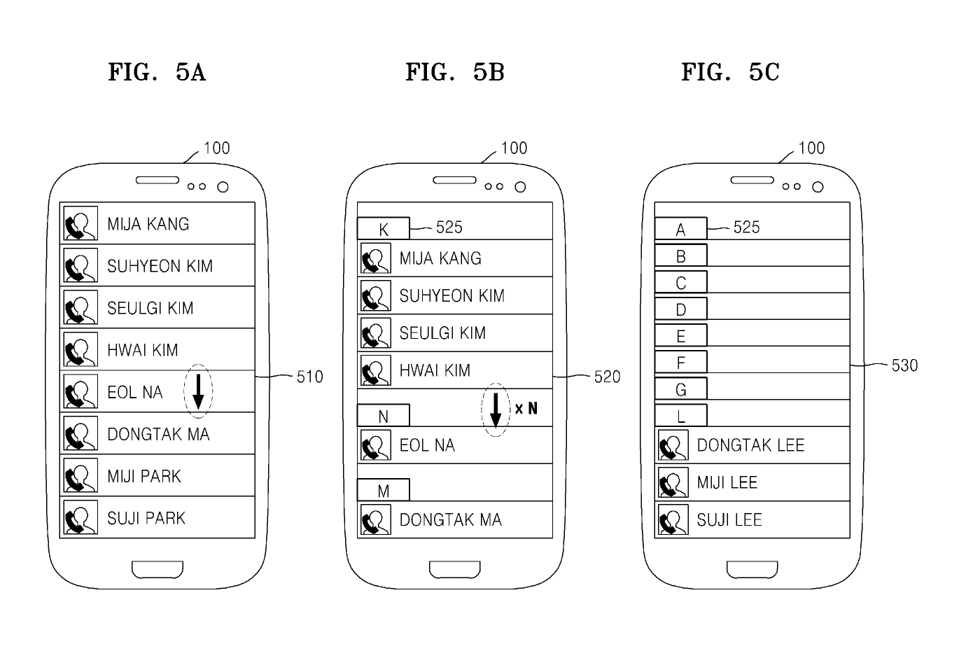

FIG. 4 is a flowchart of a method of operating the mobile terminal 100, according to an exemplary embodiment. FIGS. 5 through 16 are diagrams that are referred to for describing a method of operating the mobile terminal 100, according to various exemplary embodiments.

Referring to FIG. 4, the mobile terminal 100 may receive a user input (S410).

The user input may include a touch input with a touch tool such as an electronic pen or a finger of the user, a button input, a motion input, a voice input, and an electronic pen input. Also, the user input may further include a touch input on a bezel, an input of knocking an object on which the mobile terminal 100 is placed (for example, a table), a grip input of the mobile terminal 100, knocking an object with the mobile terminal 100, without being limited thereto.

According to the present embodiment, the touch input may include a flick input, a tap input, and an input of drawing a predetermined pattern.

“Flick” is an operation in which the user drags a finger or an electronic pen at a critical speed (for example, 100 pixel/s) or faster. The drag operation (or panning operation) and the flick operation may be distinguished from each other based on whether the speed of the finger or the electronic pen is equal to or greater than the critical speed (for example, 100 pixel/s).

“Tap” refers to an operation in which the user touches the screen with a finger or an electronic pen and then lifts the finger or the electronic pen from the screen without moving it on the screen.

The input of drawing a predetermined pattern refers to an operation in which the user touches the screen with the finger or the electronic pen and drags the finger or the electronic pen to draw a predetermined pattern.

Here, the predetermined pattern may be a circular pattern, a triangle pattern, a square pattern, and the like. Otherwise, the predetermined pattern may be a pattern that is set in advance by the user.

According to the present embodiment, a button input may include a physical user interface (PUI) button input and a GUI button input.

According to exemplary embodiments, a motion input may include a user motion input and a mobile terminal motion input. In the case of the user motion input, the mobile terminal 100 may detect the motion of the user through the camera 121. In the case of the mobile terminal motion input, the mobile terminal 100 may detect the motion of the mobile terminal 100 through an acceleration sensor or a gyro sensor.

The user motion input may include an input in which a hand or finger of the user gets far from or gets close to the mobile terminal 100, an input in which the hand or finger of the user moves from the right (left) to the left (right), an input in which the hand or finger of the user moves upward or downward, and an input in which the user folds or unfolds the hand.

Also, the mobile terminal motion input may include an input in which the mobile terminal 100 is shook left and right, and up and down, and an input in which the mobile terminal 100 gets close to or far from the user.

The mobile terminal 100 may perform a first operation corresponding to the received user input (S420).

Here, the first operation may be an operation that is set in advance in the mobile terminal 100 to correspond to the user input. Also, the first operation may be an operation based on a property of the screen displayed on the display unit 151 and a kind of the user input received by the mobile terminal 100.

For example, in a state where a list screen is displayed on the display unit 151, the mobile terminal 100 may receive an input of flicking the list screen. In this case, the mobile terminal 100 may perform an operation of scrolling the list displayed on the list screen in up and down directions according to a direction of the flicking input.

Also, in a state where the list screen is displayed on the display unit 151, the mobile terminal 100 may receive an input of drawing a predetermined pattern on the list screen. In this case, the mobile terminal 100 may operate differently depending on the direction of drawing the predetermined pattern.

For example, when the mobile terminal 100 receives an input of drawing a predetermined pattern in a first direction, the mobile terminal 100 may filter the list displayed on the list screen based on a predetermined reference, and then, may display the filtered list.

On the other hand, when the mobile terminal 100 receives an input of drawing a predetermined pattern in a second direction that is opposite to the first direction, the mobile terminal 100 may additionally display a list that is related to the list displayed on the list screen or may further display detailed information regarding the list displayed on the list screen.

Also, in a state where a home screen is displayed on the display unit 151, the mobile terminal 100 may receive an input of tapping an application icon displayed on the home screen. In this case, the mobile terminal 100 may execute the application represented by the tapped icon.

Also, in a state where a camera screen is displayed on the display unit 151, the mobile terminal 100 may receive an input of tapping a photograph icon displayed on the camera screen. In this case, the mobile terminal 100 may capture an image displayed on the camera screen.

In a state where an album screen is displayed on the display unit 151, the mobile terminal 100 may receive an input of tapping an object in an image included in the album screen. In this case, the mobile terminal 100 may tag the object.

Also, in a state where a text screen is displayed on the display unit 151, the mobile terminal 100 may receive an input of tapping a certain word displayed in the text screen. In this case, the mobile terminal 100 may select the certain word.

Also, in a case where a web page screen is displayed on the display unit 151, the mobile terminal 100 may receive a back button input that is configured as the PUI button. In this case, the mobile terminal 100 may display a previous page of the current web page.

Referring back to FIG. 4, the mobile terminal 100 may receive the user input successively for a predetermined number of times within a predetermined time period (S430).

Here, the predetermined time period and the predetermined number of times may be set in advance. The user input may include the touch input by using the touch tool such as an electronic pen or the user's hand, the button input, the motion input, the voice input, and the electronic pen input, as described above. Also, the user input may further include the touch input on the bezel, the input of knocking an object on which the mobile terminal is placed (for example, a table), the grip input, and the like.

The mobile terminal 100 may perform a second operation based on the number of times the user input is successively received (S440).

Here, the second operation may be an operation that is set in advance in relation to the first operation, as described in more detail with reference to the drawings of the display screens.

FIGS. 5A through 5C are diagrams showing the display unit 151 displaying a list screen according to exemplary embodiments.

Here, the list screen may be a screen including a list, and the list may include a phone number list, an image list, an article list, and an application list.

FIGS. 5A through 5C show a phone book screen including a phone number list 510.

The phone number list 510 may include names of people stored in the mobile terminal 100, images of the people, and telephone numbers of the people. In addition, the phone number list 510 may include a phone call icon so that the user may call another by selecting the phone call icon.

As shown in FIG. 5A, when the mobile terminal 100 receives the user input of flicking the phone book screen, the mobile terminal 100 may scroll the phone number list 510.

Here, a direction of scrolling may be determined based on a direction of the flick input. For example, when the phone book screen is flicked downward, the mobile terminal 510 scrolls the phone number list 510 down.

When the phone book screen is flicked upward, the mobile terminal 100 scrolls the phone number list 510 up.

The mobile terminal 100 may receive the user input that flicks the phone book screen successively within a predetermined time period.

Here, if the number of successively received flicking inputs is a predetermined number or more, the mobile terminal 100 may make groups of the phone number list 510 according to a predetermined reference and display the groups, as shown in FIG. 5B.

For example, the mobile terminal 100 may make groups of the phone number list 510 based on the last names of the people corresponding to the phone numbers, that is, an initial sound of a first letter in the last names of the people. The phone numbers corresponding to the last names of the people having the same initial sound may be grouped.

If groups corresponding to the phone numbers are set in advance, the phone number list 510 may be classified based on the preset groups.

Otherwise, groups may be configured based on the number of uses of the phone numbers and the time of using the phone numbers. For example, the phone number list 510 may be divided into a group of phone numbers of which the number of uses is less than 10, and a group of phone numbers of which the number of uses is 10 or greater and less than 20. Otherwise, the phone number list 510 may be divided into a group of phone numbers that have been used within this week and a group of phone numbers that have been used one week ago.

The embodiments are not limited thereto, and the groups may be made based on various references.

The mobile terminal 100 may display the phone number list 510 by group units, and may display a bookmark object 525 with the name of group on it.

The mobile terminal 100 may scroll the phone number list 510 displayed in the group, by the group unit.

For example, whenever the mobile terminal 100 receives the flick input, the mobile terminal 100 may only display the bookmark objects 525 with the names of the groups displayed on them, without displaying the phone number list 510 included in the groups, as shown in FIG. 5C.

Here, if the input is the flicking input from above to down, the bookmark objects 525 of the groups may be only displayed in an order from the top. On the other hand, if the input is the flicking input from below to up, the bookmark objects 525 of the groups may be only displayed in an order from the bottom to the top.

Also, in a state where the bookmark objects 525 with the names of groups displayed on them are displayed on the display unit 151, when the mobile terminal 100 receives an input of tapping a bookmark object 525, the mobile terminal 100 may display the phone number list included in the corresponding group as shown in FIG. 5C.

If the user repeatedly flicks the list screen in order to select a desired phone number list, the mobile terminal 100 may briefly display the groups of the phone number list, and thus, the user may easily find the desired phone number list.

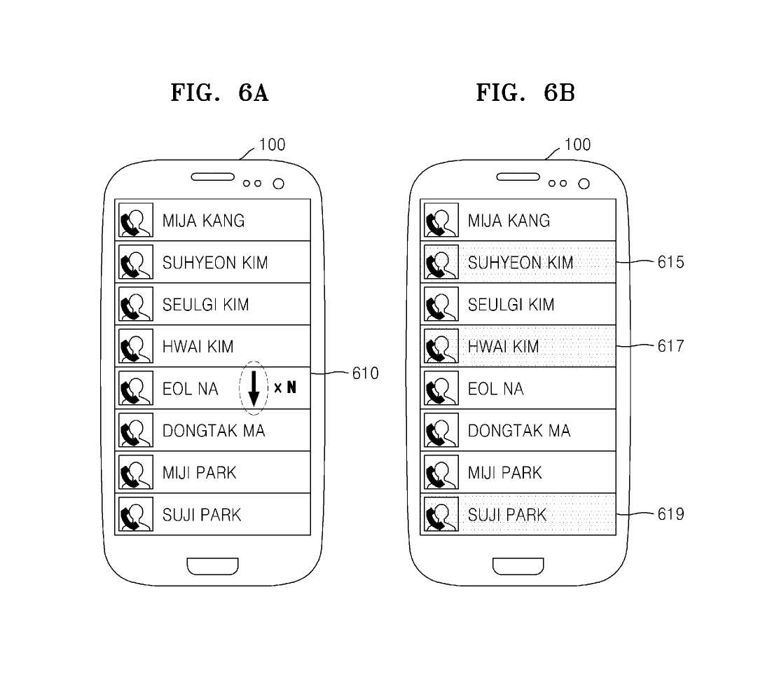

FIGS. 6A and 6B are diagrams showing a phone book screen 610 including a phone number list, according to an exemplary embodiment.

When the mobile terminal 100 receives a user input of flicking the phone book screen 610, the mobile terminal 100 may scroll the phone number list, as described with reference to FIGS. 5A through 5C, and thus, detailed descriptions thereof are omitted here.

As shown in FIG. 6A, the mobile terminal 100 may successively receive the user input of flicking the phone book screen 610 within a predetermined time period.

If the number of flicking inputs that are successively input is a predetermined number or more, the mobile terminal 100 may highlight principal lists (phone numbers) 615, 617, and 619 from among the phone number list. Also, the mobile terminal 100 may scroll the phone numbers that are not highlighted faster than the scrolling speed when the flick input is received once. Also, the mobile terminal 100 may scroll the highlighted lists 615, 617, and 619 slower than the scrolling speed when the flick input is received once.

Here, the principal list may include phone numbers having a large number of call events and message transmissions or phone numbers set by the user in advance.

Otherwise, although not shown in the drawings, the principal list may be magnified or may become stereoscopic, in addition to the highlight effect. Also, the principal list that is magnified or stereoscopic may be scrolled down slower than the scrolling speed when the flick input is received once.

When the user repeatedly flicks the phone number list in order to select a desired phone number list of the user, the mobile terminal 100 may display the principal list to be easily visible so that the user may easily select the desired phone number list.

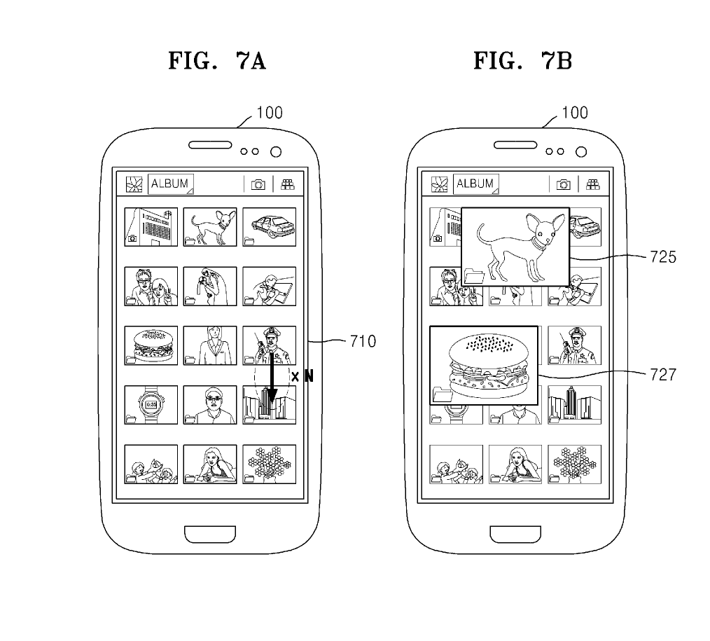

FIGS. 7A and 7B are diagrams showing an album screen 710 according to an exemplary embodiment.

The album screen 710 may include images captured by the camera, or downloaded or shared images. Also, the album screen 710 may display a list of thumbnails of the images.

When the mobile terminal 100 receives a user input of flicking the album screen 710, the mobile terminal 100 may scroll the image list.

As shown in FIG. 7A, the mobile terminal 100 may receive the user input of flicking the album screen 710 successively within a predetermined time period.

Here, when the number of successive inputs of the flicking operation is a predetermined number or more, the mobile terminal 100 magnifies principal images 725 and 727 in the image list as shown in FIG. 7B, and may control the magnified images 725 and 727 to be scrolled slower than the other images.

Also, the magnified images 725 and 727 may overlap the other images.

The principal images 725 and 727 may be images set by the user in advance. For example, the principal images 725 and 727 may be images that are bookmarked when being stored.

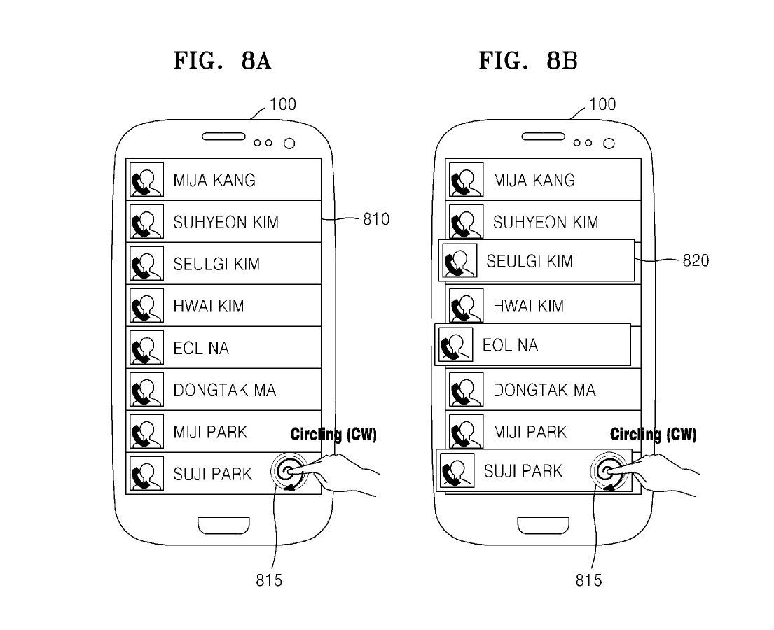

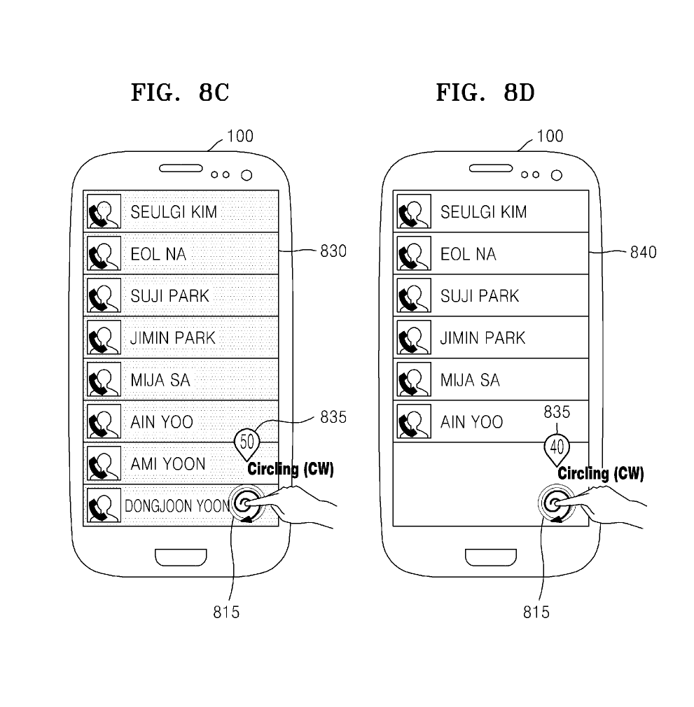

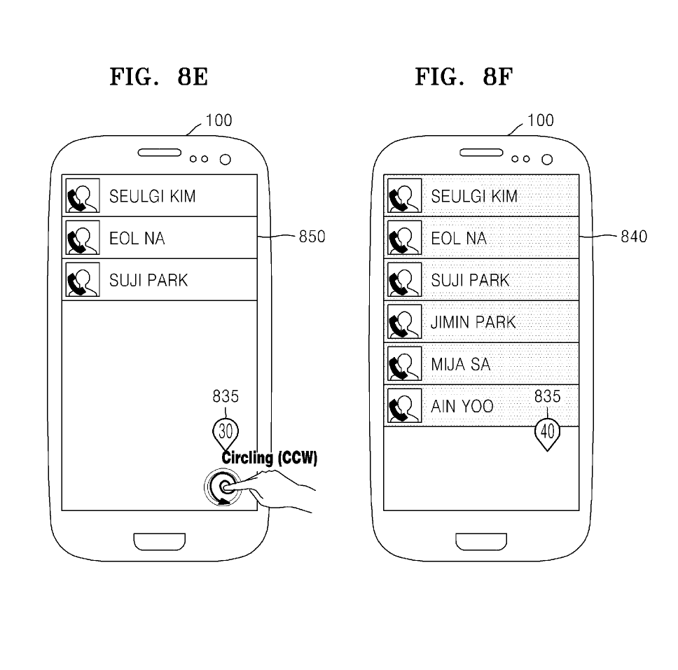

FIGS. 8A through 8F are diagrams showing a phone book screen including a phone number list, according to an exemplary embodiment.

When the mobile terminal 100 receives an input of drawing a predetermined pattern on the phone book screen, the mobile terminal 100 may filter the phone number list 810 based on a first reference.

FIGS. 8A through 8F show that the predetermined pattern is a circular pattern; however, the predetermined pattern may be various patterns, for example, a triangle, a square, and the like.

The predetermined pattern may be a pattern set in the mobile terminal 100 in advance. The mobile terminal 100 may determine whether the pattern drawn by the user is the predetermined pattern, based on a shape or a size of the pattern drawn by the user with a finger of the user or a touch tool such as an electronic pen.

In FIGS. 8A through 8F, the predetermined pattern is drawn on a right lower portion of the phone book screen; however, the embodiments are not limited thereto.

Also, the mobile terminal 100 may display an input window 815 for receiving the input of the predetermined pattern. When the user inputs the predetermined pattern in the input window 815, the mobile terminal 100 may detect the input of the predetermined pattern and performs a corresponding operation.

In addition, a predetermined pattern controller (not shown) may be displayed on a region of the phone book screen so that the user may easily recognize the predetermined pattern set in advance in the mobile terminal 100.

The predetermined pattern controller shows the user the predetermined pattern that is set in advance, and the user may input a drawing of the predetermined pattern in conjunction with the predetermined pattern controller.

For example, when the phone book screen is displayed and the predetermined pattern controller is displayed on a region of the phone book screen, the user sees the predetermined pattern controller and recognizes that it is possible to input the predetermined pattern input.

In a case where the predetermined pattern is set as the circular pattern, as shown in FIG. 8A, when the user input of drawing the circular pattern is received, the mobile terminal 100 may filter the phone number list according to the first reference.

Here, the first reference for filtering may be set in advance by the user. For example, the filtering reference may be set based on the number of uses of a phone number and the current time.

For example, the mobile terminal 100 may display the phone numbers after filtering the phone numbers having a call history of once or more. Otherwise, the mobile terminal 100 may filter the phone numbers having a call history at the time when the input of drawing the predetermined pattern is received. If the time of receiving the input of drawing the predetermined pattern is morning, the mobile terminal 100 may filter the phone numbers having a call history in the morning. On the other hand, if the time of receiving the input of drawing the predetermined pattern is evening, the mobile terminal 100 may filter the phone numbers having a call history in the evening.

Referring to FIG. 8B, the mobile terminal 100 may apply a transition effect to a filtered phone number list 820, that is, the phone number list satisfying the reference, of the phone number list.

For example, the filtered phone number list 820 may be isolated and float from the phone number list screen.

Also, although not shown in the drawings, the mobile terminal 100 may display the phone number list that does not satisfy the filtering reference to sink and disappear from the phone number list screen.

Also, the mobile terminal 100 may differentiate colors or display areas of the phone number list satisfying the reference and the phone number list that does not satisfy the reference from each other.

Referring to FIG. 8C, the mobile terminal 100 may only display the filtered phone number list on the phone book screen.

Here, the mobile terminal 100 may display a number 835 of the filtered phone number lists.

The mobile terminal 100 may display the filtered phone number lists sequentially according to importance. The importance may be determined according to a usage history of the mobile terminal 100. For example, the mobile terminal 100 may display the phone number list in an order of frequently called.

Otherwise, the mobile terminal 100 may display the phone number list in alphabetical order based on the names of people corresponding to the phone numbers.

The mobile terminal 100 may receive the input of drawing the predetermined pattern on the phone book screen successively within a predetermined time period.

Here, when the number of successive inputs is a predetermined number or more, the mobile terminal 100 may rearrange the filtered phone number list 820 according to a second reference, wherein the filtered phone number list is filtered based on the first reference.

Here, the number of successive inputs may be displayed, and a haptic effect may be generated whenever the input of drawing a predetermined pattern is received.

Also, when the number of inputs increases, the input window 815 may be changed. For example, when the number of received inputs increases, the input window 815 may be changed from a blue-based color to a red-based color.

Here, the second reference may be set in advance in the mobile terminal 100. Also, the second reference may be determined according to a direction of drawing the predetermined pattern.

For example, in a case where the user successively draws the circular pattern with a touch tool, when the user draws the circular pattern in a clockwise direction, the mobile terminal 100 may rearrange a filtered phone number list in an order of frequently called. On the other hand, when the user draws the circular pattern in a counter-clockwise direction, the mobile terminal 100 may rearrange a filtered phone number list in an order of less called.

Also, the mobile terminal 100 may increase or reduce the number of rearranged phone numbers in the phone number list based on the number of successive inputs of drawing the circular pattern for a predetermined time period.

For example, as shown in FIGS. 8C through 8E, the mobile terminal 100 may reduce the number of rearranged phone number lists 850 whenever the input of drawing the circular pattern in the clockwise (CW) direction is received.

However, as shown in FIGS. 8E and 8F, the mobile terminal 100 may increase the number of phone numbers in the rearranged phone number list 840 whenever the input of drawing the circular pattern in a counter-clockwise direction is received.

Here, the number of phone numbers in the increased or reduced lists may be set in advance.

For example, the mobile terminal 100 may reduce the number of rearranged phone number lists by 10 whenever the input of drawing the circular pattern in the clockwise direction is input. In addition, the mobile terminal 100 may increase the number of phone numbers in the phone number list by 10 whenever the input of drawing the circular pattern in a counter-clockwise direction is received. However, the embodiments are not limited thereto.

Also, the mobile terminal 100 may display the number of phone numbers in the currently displayed list on the display unit 151.

When the user repeatedly inputs a predetermined pattern on the list screen in order to select a desired phone number list, the mobile terminal 100 filters the phone number lists, and rearranged the filtered lists, and thus, the user may easily find a desired phone number list.

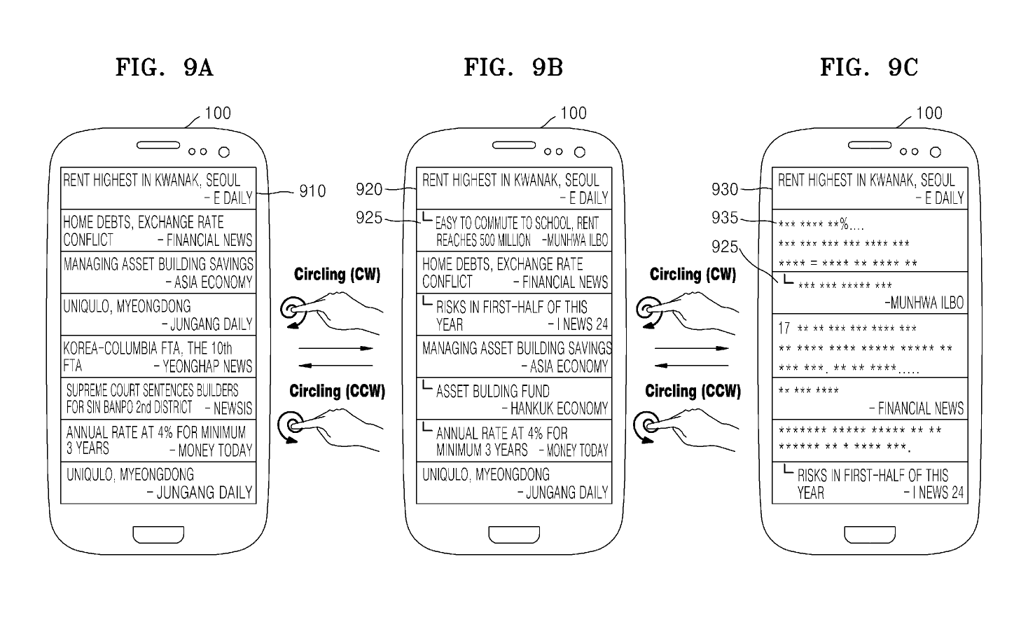

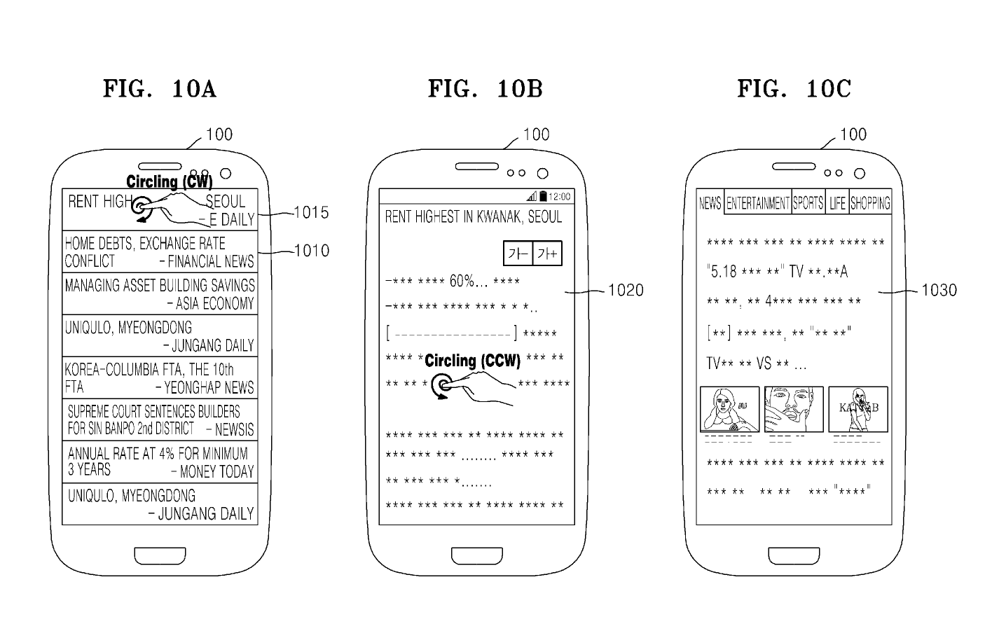

FIGS. 9 and 10 are diagrams showing a news screen including a list of article titles according to an exemplary embodiment.

When the mobile terminal 100 receives an input of drawing a predetermined pattern in a first direction on a news screen 910, under an article title list 920 (hereinafter, first article title list), the mobile terminal 100 may display a list of additional article titles 925 (hereinafter, referred to as a second article title list) that is related to the first article title list 920 as shown in FIG. 9B.

Here, the second article title list 925 may be a list of titles of the articles that are classified as a subject that is the same as the first article title list 920.

On the other hand, in a state where the first article title list 920 and the second article title list 925 are displayed, when the mobile terminal 100 receives an input of drawing a predetermined pattern in a second direction on the news screen 910, the mobile terminal 100 may only display the first article title list 920, as shown in FIG. 9A.

Also, in a state where the first article title list 920 and the second article title list 925 are displayed, when the mobile terminal 100 receives an input of drawing a predetermined pattern in the first direction on the news screen 910, the mobile terminal 100 may display some of the content 935 of the corresponding article under the first article title list 920.

On the other hand, in a state where the first article title list 920, the second article title list 925, and some of the article content 935 are displayed, when the mobile terminal 100 receives an input of drawing the predetermined pattern in the second direction on the news screen 910, the mobile terminal 100 may not display the content 935 of the corresponding article, as shown in FIG. 9B.

In addition, the mobile terminal 100 may successively receive a predetermined number of inputs of drawing the predetermined pattern in the first direction on the news screen 910 within a predetermined time period. For example, as shown in FIG. 10A, the mobile terminal 100 receives the input of drawing the predetermined pattern in the first direction on a region on which a title of one of the articles from among the first article title list 920 from a news screen 1010 on which a first article title list 1015 is displayed, a lowest page 1020 that is related to the corresponding article may be displayed as shown in FIG. 10B.

On the contrary, when receiving an input of drawing the predetermined pattern in the second direction on the news screen 1010 on which the lowest page 1020 that is related to the corresponding article is displayed, the mobile terminal 100 may display a highest page 1030 of the news screen 1010 as shown in FIG. 10C. Otherwise, although not shown in the drawings, the web page of a newspaper company showing the corresponding article may be displayed.

Although not shown in the drawings, in a state of displaying the news screen, when the mobile terminal 100 senses shaking of a predetermined magnitude or greater once or more, the mobile terminal 100 may control advertisement contents that are not related to the news displayed on the article screen not to be displayed.

Here, a visible effect that the advertisement contents fall down in the direction of gravity and disappear may be displayed. Also, a visible effect that the advertisement contents crash onto a bezel portion and disappear may be displayed, and a haptic effect may be applied to the crashed portion.

Also, when detecting shaking of a predetermined magnitude or greater successively for a predetermined number of times or more, a mobile terminal 100 may not display images in a news screen or may summarize the news content.

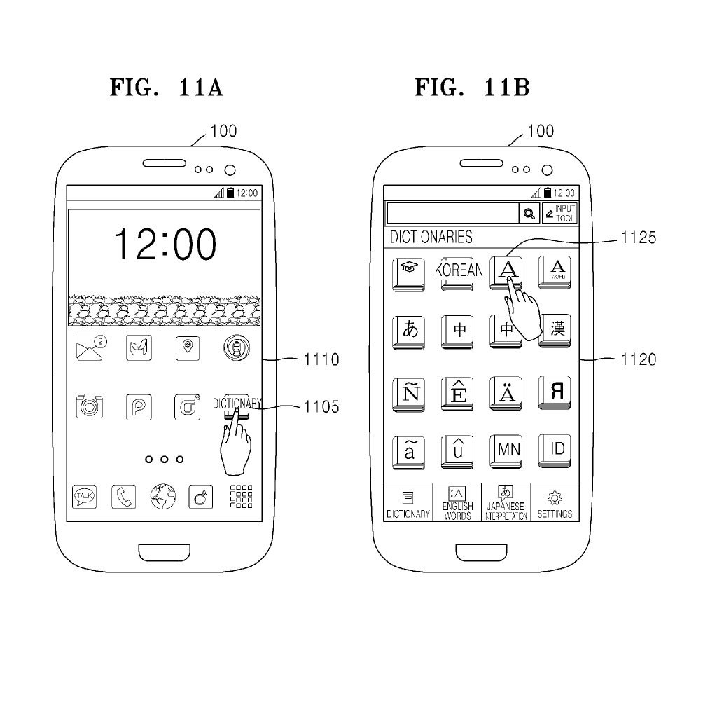

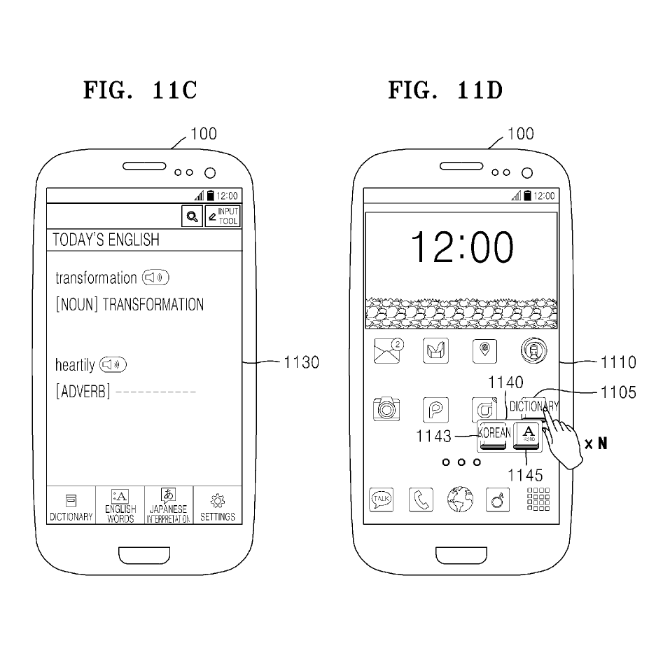

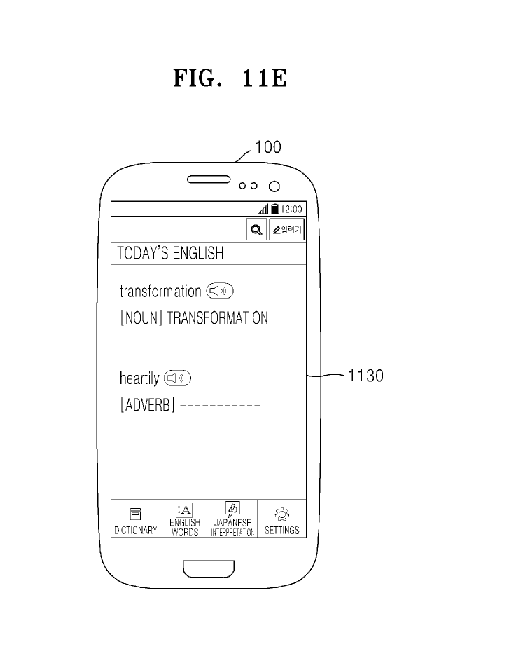

FIG. 11A is a diagram showing a home screen 1110 of the mobile terminal 100, according to an exemplary embodiment.

Referring to FIG. 11A, the home screen 1110 is a basic screen of the mobile terminal 100, and the home screen 1110 may include application icons representing applications.

An application may be one of application programs executing various functions of the mobile terminal 100.

For example, the applications may include an application of executing a camera function, a dictionary application, a social network-related application executing a social network service, an application of executing an album screen, an application executing a calling function, an application of executing a memo function, an application of executing an alarm/clock function, an application of reproducing an audio file or a video file, and the like, and the embodiments are not limited thereto.

Also, the application icons representing the applications may be displayed as various images, and locations and orders of displaying the application icons may be determined according to settings of the user.

The mobile terminal 100 may receive an input of tapping an application icon displayed on the home screen 1110.

For example, the mobile terminal 100 may receive an input of tapping a dictionary application icon 1105, as shown in FIG. 11A.

The mobile terminal 100 may execute the tapped application.

For example, the mobile terminal 100 may execute a dictionary application, as shown in FIG. 11B, and may display an execution screen 1120.

The execution screen 1120 may display various lower level menus. For example, the dictionary application may include various dictionary menus, for example, a Korean dictionary menu, an English dictionary menu, a Japanese dictionary menu, an encyclopedia menu, etc.

The mobile terminal 100 may receive an input of selecting one of the menus. For example, when the mobile terminal 100 receives an input of selecting an English dictionary menu 1125, the mobile terminal 100 may display an English dictionary execution screen 1130 as shown in FIG. 11C.

In addition, the mobile terminal 100 may successively receive the input of tapping the application icon for a predetermined number of times within a predetermined time period.

For example, the mobile terminal 100 may receive the input of successively tapping the dictionary application icon 1105. When receiving the successive input, as shown in FIG. 11D, the mobile terminal 100 may display a lower level menu 1140 that is related to the corresponding application on the home screen 1110. Here, the lower level menu 1140 may be displayed within a predetermined distance from the corresponding application icon 1105.

Also, the related lower level menu 1140 may be a menu that the user frequently uses, based on a usage history of the corresponding application. Otherwise, the related lower level menu 1140 may be a menu set by the user in advance.

For example, as a result of analyzing the user's usage history of the dictionary application, when the user frequently uses the English dictionary function and the Korean dictionary function, the mobile terminal 100 may display an English dictionary menu 1145 and a Korean dictionary menu 1143 as shown in FIG. 11D.

The mobile terminal 100 receives an input of selecting one of the lower level menus 1140 displayed on the screen, and may execute the selected lower level menu.

For example, when receiving an input of selecting the English dictionary menu 1145, the mobile terminal 100 may display the English dictionary execution menu 1130, as shown in FIG. 11E.

As described above, when the user repeatedly performs the tap input in order to execute the application that the user frequently uses, the mobile terminal 100 displays the lower level menu that is frequently used, and thus, the user may easily execute the desired application function.

Otherwise, when receiving the input of successively tapping the application icon 1105, the mobile terminal 100 may execute a certain function that is related to the application.

Here, the certain function may be set by the user. Otherwise, the mobile terminal 100 may analyze the function frequently used by the user based on the application usage history of the user. Accordingly, the mobile terminal 100 may set the function that the user frequently uses as the certain function.

For example, when receiving an input of successively tapping the dictionary application icon 1105, the mobile terminal 100 may directly execute the English dictionary execution screen 1130.

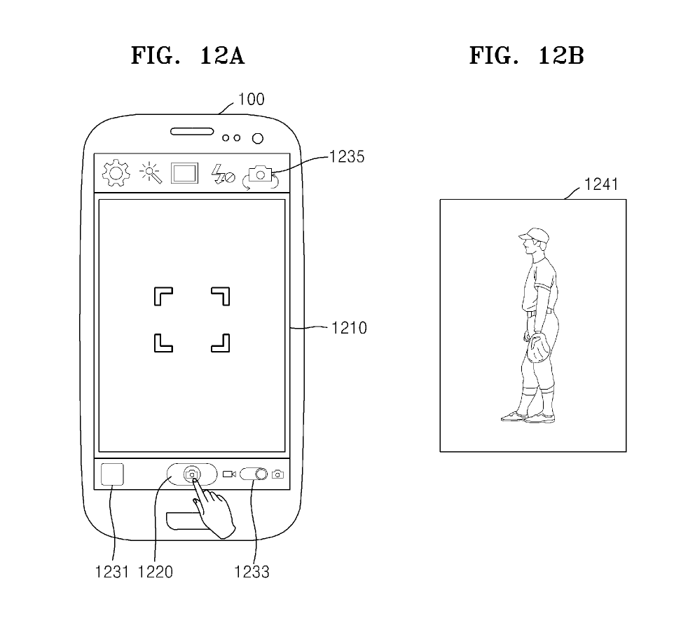

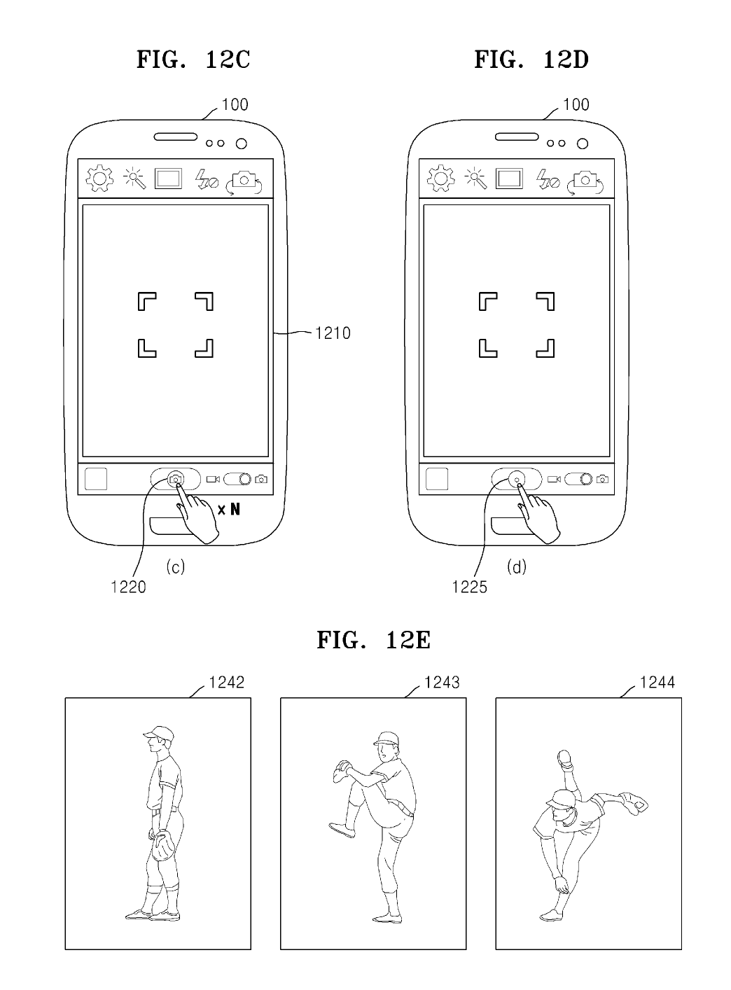

FIG. 12A is a diagram showing a camera screen according to an exemplary embodiment.

When the user selects a camera application from the menu screen, the mobile terminal 100 may execute a camera program to enter a photographing mode.

When entering the photographing mode, the mobile terminal 100 may display the camera screen on the display unit 151, as shown in FIG. 12A.

The camera screen may include a region 1210 displaying an image captured by the camera, a region displaying a plurality of menu icons for photographing, and a preview window 1231 displaying a preview image of the captured image.

The plurality of menu icons for photographing may include a photographing icon 1220 for executing a photographing operation, a picture/moving picture conversion icon 1233 for converting between a picture photographing mode and a moving picture photographing mode, and a photographing direction changing icon 1235 for changing a photographing direction.

As shown in FIG. 12A, when receiving the input of tapping the photographing icon 1220 by the user, the mobile terminal 100 may perform a photographing operation. Here, as shown in FIG. 12B, the mobile terminal 100 may take one image 1241 and stores the captured image whenever the input of tapping the photographing icon 1220 is received.

The mobile terminal 100 may successively receive the input of tapping the photographing icon 1220 within a predetermined time period. Here, the number of successive inputs of tapping the icon, the photographing operation may be performed in a stop motion mode.

The stop motion mode is a mode for successively capturing images with predetermined intervals. When the photographing is performed in the stop motion mode, the photographing icon 1220 may be changed into a stop icon 1225 for suspending a photographing operation as shown in FIG. 12D.

For example, when the user successively taps the photographing icon 1220 three times or greater within a predetermined time period, the mobile terminal 100 may successively capture a plurality of images 1242, 1243, and 1244 with predetermined intervals until the input of tapping the stop icon 1225 is received as shown in FIG. 12E.

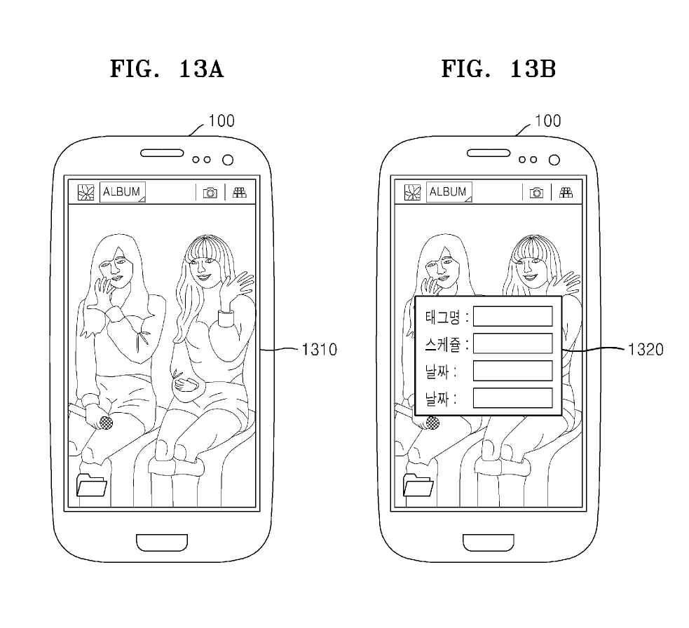

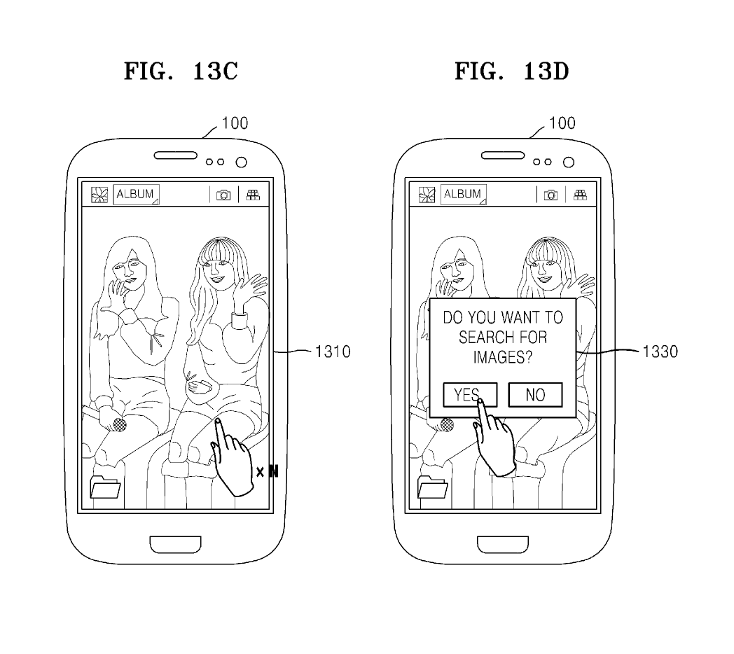

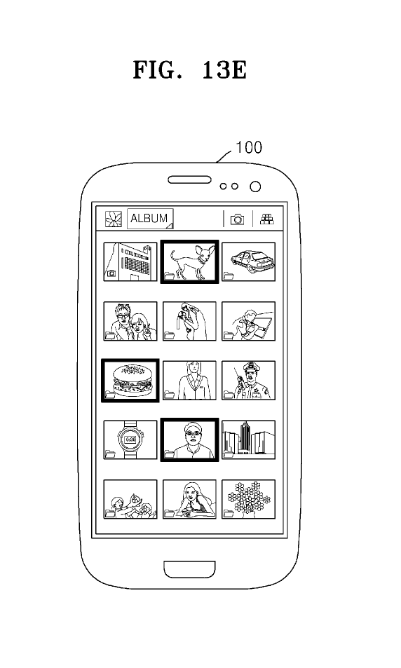

FIG. 13A is a diagram showing an album screen of the mobile terminal 100, according to an exemplary embodiment.

For example, when a user input for selecting an album application is performed, the mobile terminal 100 may enter an album mode.

When the mobile terminal 100 enters the album mode, an image list, including a plurality of images, may be displayed on the display unit 151.

When receiving an input of selecting one of the plurality of images, the mobile terminal 100 may display the image as shown in FIG. 13A.

The image 1310 may include at least one object. Here, when the mobile terminal 100 receives the input of tapping the object included in the image 1310, the mobile terminal 100 may display a tag menu window 1320 for tagging the object, as shown in FIG. 13B.

Tag information may be input to the tag menu window 1320, and the tag menu window 1320 may be displayed as a pop-up window; however, the embodiments are not limited thereto.

The tag information may include information, such as a name of the object in the image, a schedule, anniversary, a location, or the weather, that is relevant to the object.

The mobile terminal 100 may store the object with the tag information in the memory 160 when the object is tagged. In addition, the mobile terminal 100 may display the tagged object with the tag information.

For example, when the name of the object is input as the tag information, the mobile terminal 100 may display the tagged object with the object's name.

In addition, if the object is tagged with the schedule or anniversary information, the mobile terminal 100 may output the image, including the tagged object, with an alarm signal at the date or time that is set as the schedule or the anniversary.

In addition, as shown in FIG. 13C, the mobile terminal 100 may successively receive the input of tapping the object included in the image for a predetermined number of times of more within a predetermined time period.

When receiving the input of tapping a certain object successively, the mobile terminal 100 may display a message window 1310 requesting the user whether a search operation for a certain object is to start as shown in FIG. 13D.

Here, when the user selects ‘yes’, the mobile terminal 100 may detect the tapped object. The mobile terminal 100 may perform a search operation to find whether the tapped object is included in the plurality of images stored in an album folder.

When an image, including the certain object, is found, as shown in FIG. 13E, the mobile terminal 100 may display the found image.

Here, the album screen, including the image list, may be displayed, and the images, in which the certain object is found, may be highlighted or checked.

Otherwise, the images having the certain object may be only displayed in the image list of the album screen.

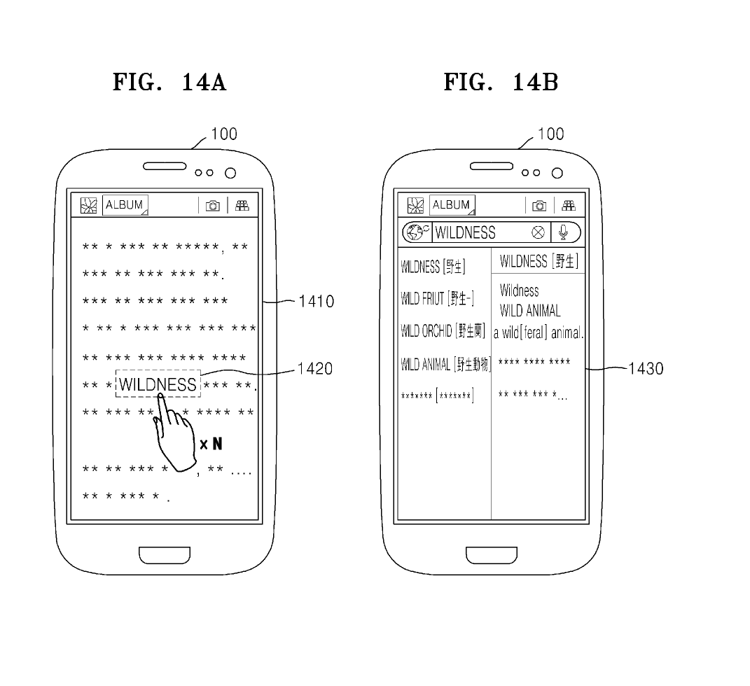

FIG. 14A is a diagram showing a text screen according to an exemplary embodiment.

The text screen may include text, and may also include various contents besides the text.

For example, as shown in FIG. 14A, the text screen may be an electronic book screen 1410. When the user selects an electronic book application from the menu screen, the mobile terminal 100 may execute the electronic book application on the display unit 151 to display the electronic book screen 1410.

As shown in FIG. 14A, when the mobile terminal 100 receives an input of tapping a certain word 1420 displayed on the electronic book screen 1410 from the user, the mobile terminal 100 may select the certain word 1420. Here, the selected word may be highlighted or underlined. Otherwise, the selected word may be magnified.

In addition, the mobile terminal 100 may successively receive the input of tapping the certain word 1420 within a predetermined time period. Here, when the number of successive inputs is a predetermined number or more, information that is related to the certain word 1420 may be displayed.

For example, in communication with an Internet application, a result of searching for a Web site about the certain word may be displayed, or a result screen 1430 of searching for the certain word 1420 in a dictionary application may be displayed. However, the embodiments are not limited thereto, that is, information that is related to the certain word 1420 may be variously displayed by using other applications.

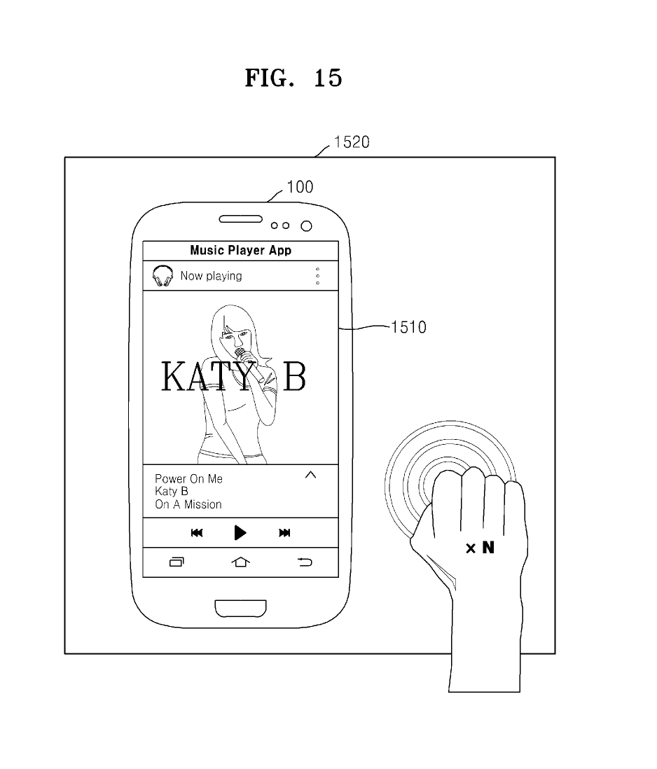

FIG. 15 is a diagram showing a screen in which a music application is executed according to an exemplary embodiment.

The mobile terminal 100 may execute the music application to enter a music playing mode, as shown in FIG. 15.

Here, the mobile terminal 100 may display a music play screen 1510. The music play screen 1510 may include information about a song that is currently playing, for example, a song title, lyrics, and a singer's name.

Also, the mobile terminal 100 may display buttons having various functions, for example, a pause button, a back button for replaying a previous song, a forward button for playing a next song, and the like.

Also, the mobile terminal 100 may be placed on an object 1520 such as a table, as shown in FIG. 15.

Here, since the mobile terminal 100 contacts the object, the mobile terminal 100 may detect sound or vibration generated from the object 1520 through various sensors.

Accordingly, the mobile terminal 100 may receive an input of knocking the object 1520 such as the table.

When receiving the knock input, the mobile terminal 100 may play the previous song or the next song.

Here, the mobile terminal 100 may play the previous song or the next song depending on a direction of the knock input. For example, if the knock input is received from a right side of the mobile terminal 100, the mobile terminal 100 may reproduce the next song. Otherwise, if the knock input is received from a left side of the mobile terminal 100, the mobile terminal 100 may reproduce the previous song.

In addition, the mobile terminal 100 may successively receive the knock inputs for a predetermined number of times or more within a predetermined time period.

For example, when the mobile terminal 100 successively receives the knock input twice within a predetermined time period, the mobile terminal 100 may continuously jump to the previous song or the next songs until the knock input is received again after a predetermined time has passed.

Here, the mobile terminal 100 may display the information about the songs.

In addition, the mobile terminal 100 may jump to the previous songs or the next songs continuously according to a direction of the knock input. For example, when the successive knock inputs are received from the right side of the mobile terminal 100, the mobile terminal 100 may continuously jump to the next songs. On the other hand, if the successive knock inputs are received from the left side of the mobile terminal 100, the mobile terminal 100 may continuously jump to the previous songs.

After having jumped to the previous or next songs, if the mobile terminal 100 receives the knock input again, the mobile terminal 100 may reproduce a currently selected song.

FIG. 15 shows the knock input as an example; however, the embodiments are not limited thereto, and the mobile terminal 100 may operate in the same way as the knock input with respect to the forward button input and the back button input.

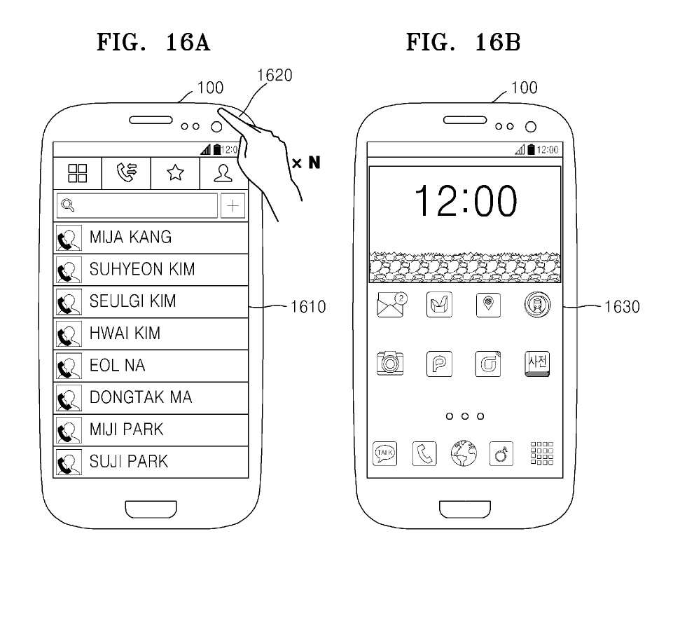

FIG. 16A is a diagram showing a phone book screen of the mobile terminal 100, according to an exemplary embodiment. The mobile terminal 100 may execute a phone book application to display a list screen including a phone number list.

Here, the mobile terminal 100 may receive an input of tapping a bezel 1620. When receiving the input of tapping the bezel 1620, the mobile terminal 100 may display a beginning or an end of a phone number list 1610.

For example, when receiving an input of tapping an upper portion of the bezel 1620, the mobile terminal 100 may display the beginning of the phone number list 1610, and when receiving an input of tapping a lower portion of the bezel 1620, the mobile terminal 100 may display the end of the phone number list 1610.

The mobile terminal 100 may successively receive the input of tapping the bezel 1620 for a predetermined number of times or more within a predetermined time period. When successively receiving the input of tapping the bezel 1620, the mobile terminal 100 may display an upper level menu screen. Here, as shown in FIG. 16B, the upper level menu screen may be a home screen 1630.

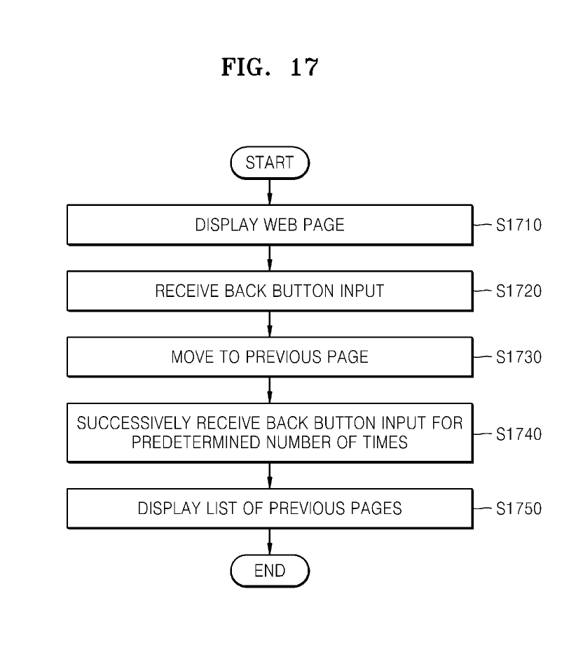

FIG. 17 is a flowchart of a method of operating the mobile terminal 100, according to an exemplary embodiment.

Referring to FIG. 17, the mobile terminal 100 may display a web page on the display unit 151 (S1710).

For example, when receiving an input of selecting an icon representing an Internet application, the mobile terminal 100 executes the Internet application and displays a web page. The web page is a page displaying Web documents on the Internet, and may include various contents.

The mobile terminal 100 may receive a back button input (S1720). The back button may be a GUI button or a PUI button, or may be configured as a physical button.

Hereinafter, it is assumed that the back button is a PUI button for convenience of description. Accordingly, the back button input may be an input of touching the back button.

The back button input is an input for moving to a previous page of the currently displayed web page on the mobile terminal 100. In addition, the back button input is an input for moving to an upper level menu from a lower level menu. Otherwise, the back button input is an input for moving to upper level information from lower level information.

Accordingly, the mobile terminal 100 may display the previous page of the current web page (S1730).

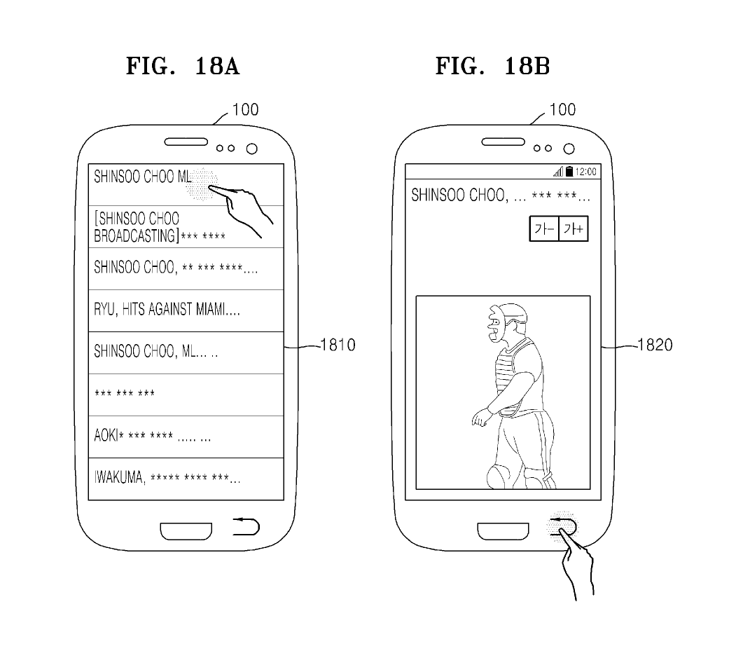

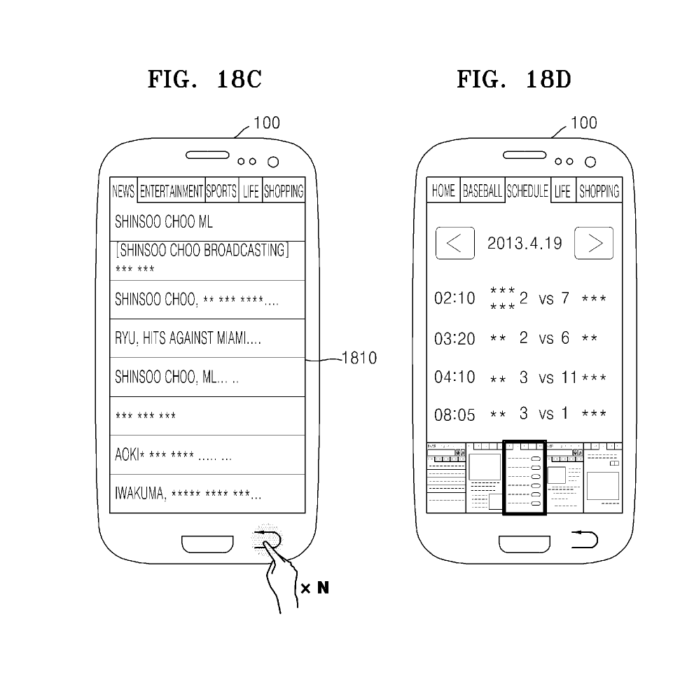

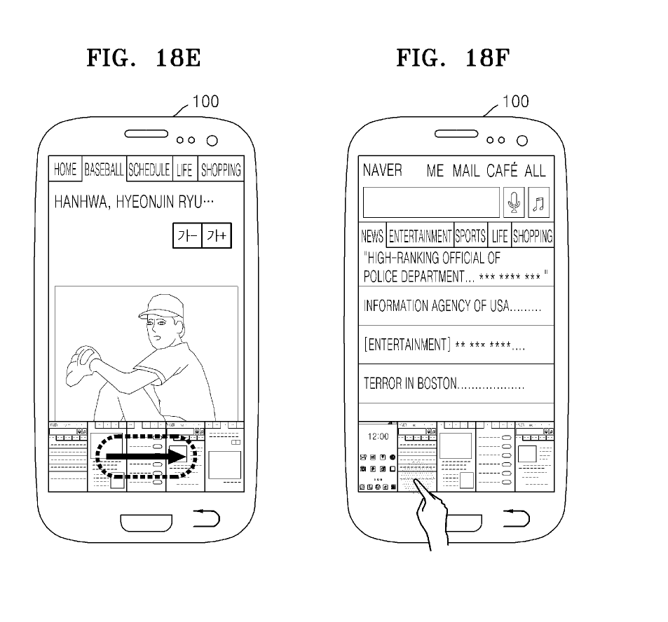

For example, as shown in FIG. 18A, the mobile terminal 100 may display a first web page 1810. Here, the first web page 1810 may be a page including a news list.

In addition, when receiving a touch input for selecting one of the news articles in the list from the user, the mobile terminal 100 may display a second web page 1820, as shown in FIG. 18B. Here, the second web page 1820 may include an image or an article that is related to the selected news article list.

As shown in FIG. 18B, in a state of displaying the second web page 1820, when the mobile terminal 100 receives a back button input 1825, the mobile terminal 100 displays the first web page 1810, as shown in FIG. 18C (S1730).

The mobile terminal 100 may successively receive the back button input 1825 for a first number of times or more within a predetermined time period (S1740). Here, the predetermined time period may be set in advance, and the first number of times may be set in advance.

When successively receiving the back button input 1825, the mobile terminal 100 may display a list 1830 of previous pages, as shown in FIG. 18D (S1750).

Here, the list 1830 of previous pages may be a list showing the pages that are displayed before the current page. Otherwise, the list 1830 may include higher level pages of the currently displayed web page.

For example, in a case where the mobile terminal 100 displays a second web page, a third web page, a fourth web page, and a first web page in order to display the first web page, the second through fourth web pages are the previous pages of the first web page.

The list 1830 of previous pages may be displayed on a lower portion of the web page, as shown in FIG. 18D; however, the embodiments are not limited thereto.

The list 1830 of previous pages may display thumbnails representing the previous pages. Here, the thumbnails may be reduced images of the previous pages.

Referring to FIG. 18E, if it is difficult to display the thumbnails of the previous pages in one screen, the list of the previous pages may be scrolled in left and right directions so that the user may scroll the list in the left and right directions by inputting a flick operation.

As shown in FIG. 18F, the mobile terminal 100 may receive an input of selecting one of the previous pages.

In addition, a selection object may be further displayed in the thumbnail list of the previous pages. Accordingly, when the user selects one of the plurality of previous page thumbnails, the selection object may be displayed on the selected previous page thumbnail.

The mobile terminal 100 may display a web page corresponding to the thumbnail on which the selection object is displayed.

In a case where the user repeatedly inputs the back button in order to move to the desired previous web page, the mobile terminal 100 displays the previous page list, and then, the user may easily see the desired previous page.

Although not shown in the drawings, the mobile terminal 100 may successively receive the back button inputs for a second number of times or more within a predetermined time period. Here, the second number of times may be set in advance, and may be greater than the first number of times.

When receiving the back button input for the second number of times or more, the mobile terminal 100 may display a certain page. The certain page may be a web page that is set in advance or a home screen of the mobile terminal 100.

The mobile terminal according to the embodiments may perform an operation suitable for the intention of the user when the same user input is successively received, and thus, the effort and time of the user performing a predetermined operation on the mobile terminal may be reduced.

Accordingly, user convenience may be improved.

The computer-readable code can be recorded/transferred on a medium in a variety of ways, with examples of the medium including recording media, such as magnetic storage media (e.g., ROM, floppy disks, hard disks, etc.) and optical recording media (e.g., CD-ROMs or DVDs), and transmission media such as Internet transmission media. Thus, the medium may be such a defined and measurable structure including or carrying a signal or information, such as a device carrying a bitstream according to one or more embodiments. The media may also be a distributed network, so that the computer-readable code is stored/transferred and executed in a distributed fashion. Furthermore, the processing element could include a processor or a computer processor, and processing elements may be distributed and/or included in a single device.

It should be understood that the exemplary embodiments described therein should be considered in a descriptive sense only and not for purposes of limitation. Descriptions of features or aspects within each embodiment should typically be considered as available for other similar features or aspects in other embodiments.

While one or more embodiments have been described with reference to the figures, it will be understood by those of ordinary skill in the art that various changes in form and details may be made therein without departing from the spirit and scope of the inventive concept as defined by the following claims.

What is claimed is:

1. A method of operating a mobile terminal, the method comprising:
receiving a user input;
performing a first operation corresponding to the user input;
successively receiving the user input for a predetermined number of times or more within a predetermined time period; and
performing a second operation based on a number of the successively received user input,
wherein the second operation is set in advance in relation to the first operation.

2. The method of claim 1, further comprising displaying a program execution screen,
wherein the first operation and the second operation are operations based on characteristics of the program execution screen.

3. The method of claim 1, wherein the first operation and the second operation are based on a kind of the user input.

4. The method of claim 1, further comprising displaying a list screen including a list,
wherein if the user input is an input of flicking the list screen, the performing the first operation comprises scrolling the list, and the performing the second operation comprises grouping items in the list based on a predetermined reference and scrolling groups of the list.

5. The method of claim 1, further comprising displaying a list screen including a list,
wherein if the user input is an input of flicking the list screen, the performing the first operation comprises scrolling the list, and the performing the second operation comprises highlighting a predetermined portion of the list, scrolling a portion that is not highlighted faster than a predetermined speed, and scrolling the highlighted predetermined portion of the list slower than the predetermined speed.

6. The method of claim 5, wherein the predetermined portion of the list is magnified.

7. The method of claim 1, further comprising displaying a list screen including a list,
wherein if the user input is an input of drawing a predetermined pattern on the list screen, the performing the first operation comprises filtering items in the list according to a first reference, and the performing the second operation comprises rearranging the filtered items in the list based on a second reference.

8. The method of claim 7, wherein the predetermined pattern is a circular pattern, and the second reference is determined according to a direction of drawing the circular pattern.

9. The method of claim 8, wherein the list screen is a phone number list screen,
wherein if the circular pattern is drawn in a clockwise direction, the filtered items in the list is rearranged in an order of frequently called, and if the circular pattern is drawn in a counter-clockwise direction, the filtered items in the list is rearranged in an order of less called.

10. The method of claim 7, wherein the performing the second operation comprises reducing or increasing a number of items in the list that are rearranged, based on a number of the successively received user input of drawing the predetermined pattern.

11. The method of claim 10, wherein the predetermined pattern is a circular pattern, and the performing the second operation comprises reducing a number of items in the list that are rearranged whenever an input of drawing the circular pattern in the clockwise direction is received, and increasing the number of items in the list that are rearranged whenever an input of drawing the circular pattern in the counter-clockwise direction is received.

12. The method of claim 1, further comprising displaying a screen including application icons representing applications,
wherein if the user input is an input of tapping one of the application icons, the performing the first operation comprises executing an application corresponding to the tapped application icon, and the performing the second operation comprises displaying a lower level menu that is related to the application.

13. The method of claim 1, further comprising entering a photographing mode and displaying a camera screen including a photographing icon,
wherein if the user input is an input of tapping the photographing icon, the performing the first operation comprises capturing an image displayed on the camera screen once, and the performing the second operation comprises successively capturing images displayed on the camera screen in a stop motion mode.

14. The method of claim 1, further comprising entering an album mode and displaying an album screen including images,
wherein if the user input is an input of tapping an object included in one of the images, the performing the first operation comprises tagging the object, and the performing the second operation comprises searching for an image including the object from among the images included in the album screen and displaying the searched image.

15. The method of claim 1, further comprising displaying a text screen,
wherein if the user input is an input of tapping a word included in the text screen, the performing the first operation comprises selecting the word, and the performing the second operation comprises displaying information that is related to the selected word.

16. The method of claim 15, wherein the information that is related to the selected word comprises a result of searching for the word.

17. The method of claim 1, further comprising displaying an application execution screen,
wherein if the user input is a certain key input, the performing the first operation comprises displaying a previous screen of the application execution screen, and the performing the second operation comprises displaying a list of previous screens including previous screens of the application execution screen.

18. The method of claim 1, further comprising displaying a music play screen,
wherein if the user input is an input of knocking an object contacting the mobile terminal,
wherein the performing the first operation comprises reproducing a next song of a currently played song, and
wherein the performing the second operation comprises jumping to next songs continuously until another user input is received after the predetermined time period and reproducing a song to which the jumping is made when the other user input is received.

19. A mobile terminal comprising:
a display unit configured to display information processed by the mobile terminal; and
a control unit configured to receive a user input to perform a first operation corresponding to the user input, and successively receive the user input for a predetermined number of times within a predetermined time period for performing a second operation based on a number of the successively received user input,
wherein the second operation is set in advance in relation to the first operation.

20. The mobile terminal of claim 19, wherein the display unit is further configured to display a program execution screen, and
wherein the first operation and the second operation are based on characteristics of the program execution screen.

21. The mobile terminal of claim 19, wherein the first operation and the second operation are based on a kind of the user input.

22. The mobile terminal of claim 19, wherein the display unit is configured to display a list screen including a list, and
wherein if the user input is an input of flicking the list screen, the first operation is an operation of scrolling the list, and the second operation is an operation of grouping items in the list based on a predetermined reference and scrolling the groups of the list.

23. The mobile terminal of claim 19, wherein the display unit is configured to display a list screen including a list, and
wherein if the user input is an input of flicking the list screen, the first operation is an operation of scrolling the list, and the second operation is an operation of highlighting a predetermined portion of the list, scrolling a portion of the list that is not highlighted faster than a predetermined speed when performing the first operation, and scrolling the highlighted predetermined portion of the list slower than the predetermined speed.

24. The mobile terminal of claim 23, wherein the control unit is configured to magnify the predetermined portion of the list.

25. The mobile terminal of claim 19, wherein the display unit is configured to display a list screen including a list, and
wherein if the user input is an input of drawing a predetermined pattern on the list screen, the first operation is an operation of filtering items in the list according to a first reference, and the second operation is an operation of rearranging the filtered items in the list based on a second reference.

26. The mobile terminal of claim 25, wherein the predetermined pattern is a circular pattern, and the second reference is determined according to a direction of drawing the circular pattern.

27. The mobile terminal of claim 26, wherein the list screen is a phone number list screen, and
wherein if the circular pattern is drawn in a clockwise direction, the control unit is configured to rearrange the filtered items in the list in an order of frequently called, and if the circular pattern is drawn in a counter-clockwise direction, the control unit is configured to rearrange the filtered items in the list in an order of less called.

28. The mobile terminal of claim 25, wherein the control unit is configured to reduce or increase a number of items in the list that are rearranged, based on a number of the successively received user input of drawing the predetermined pattern.

29. The mobile terminal of claim 28, wherein the predetermined pattern is a circular pattern, and the control unit is configured to reduce a number of items in the list that are rearranged whenever an input of drawing the circular pattern in the clockwise direction is received, and increase the number of items in the list that are rearranged whenever an input of drawing the circular pattern in the counter-clockwise direction is received.

30. The mobile terminal of claim 19, wherein the display unit is configured to display a screen including application icons representing applications, and
wherein if the user input is an input of tapping one of the application icons, the first operation is an operation of executing an application corresponding to the tapped application icon, and the second operation is an operation of displaying a lower level menu that is related to the application.

31. The mobile terminal of claim 19, wherein the display unit is configured to display a camera screen including a photographing icon, and
wherein if the user input is an input of tapping the photographing icon, the first operation is an operation of capturing an image displayed on the camera screen once, and the second operation is an operation of successively capturing images displayed on the camera screen in a stop motion mode.

32. The mobile terminal of claim 19, wherein the display unit is configured to display an album screen including images, and
wherein if the user input is an input of tapping an object included in one of the images, the first operation is an operation of tagging the object, and the second operation is an operation of searching for an image including the object from among the images included in the album screen and displaying the searched image.

33. The mobile terminal of claim 19, wherein the display unit is configured to display a text screen, and
wherein if the user input is an input of tapping a word included in the text screen, the first operation is an operation of selecting the word, and the second operation is an operation of displaying information that is related to the selected word.

34. The mobile terminal of claim 33, wherein the information that is related to the selected word comprises a result of searching for the word.

35. The mobile terminal of claim 19, wherein the display unit is configured to display an application execution screen, and
wherein if the user input is a certain key input, the first operation is an operation of displaying a previous screen of the application execution screen, and the second operation is an operation of displaying a list of previous screens including previous screens of the application execution screen.

36. The mobile terminal of claim 19, wherein the display unit is configured to display a music play screen, and
wherein if the user input is an input of knocking an object contacting the mobile terminal, the first operation is an operation of reproducing a next song of a currently played song, and the second operation is an operation of jumping to next songs continuously until another user input is received after the predetermined time period, and reproducing a song to which the jumping is made when the other user input is received.

37. A method of operating a mobile terminal, the method comprising:
displaying a web page;
receiving a back button input;
displaying a previous page of the web page;
successively receiving the back button input for a first number of times or more within a predetermined time period; and
displaying a list of previous pages of the web page.

38. The method of claim 37, wherein the list of previous pages is a list of thumbnails of the previous pages.

39. The method of claim 37, further comprising:
selecting one previous page of the list of previous pages; and
displaying the selected previous page.

40. The method of claim 37, further comprising:
successively receiving the back button input for a second number of times or more within a predetermined time period; and
displaying a preset page,
wherein the second number of times is greater than the first number of times.

41. A computer-readable recording medium having embodied thereon a program for executing the method of claim 1.
